(19) United States
(12) Patent Application Publication
(10) Pub. No.: US 2026/0181070 A1
(43) Pub. Date: Jun. 25, 2026

(54) IDENTIFICATION OF HARASSMENT COMMUNICATION

(71) Applicant: Intrado Life & Safety, Inc., Longmont, CO (US)

(72) Inventors: John Lawrence Snapp, Everett, WA (US); Patrick Arsenault, Montreal (CA); Marc D. Cravens, Nixa, MO (US)

(21) Appl. No.: 18/989,758

(22) Filed: Dec. 20, 2024

(51) Int. Cl. H04M 3/22; H04M 3/493; H04M 3/51

(52) U.S. Cl. CPC H04M 3/2281; H04M 3/5116; H04M 3/493

(57) ABSTRACT

Particular example embodiments described herein can provide for a system, an apparatus, and a method for analyzing a communication from an electronic device to a public-safety answering point (PSAP), determining a harassment confidence score that indicates a likelihood the communication is a harassment communication, and sending the communication and the determined harassment confidence score for the communication to a human operator at the PSAP. In some examples, the harassment communication is a swatting attempt.

### TECHNICAL FIELD

This disclosure relates in general to the field of computing and/or networking and, more particularly, to a system, an apparatus, and a method to enable the identification of a harassment communication.

### BACKGROUND

A public-safety answering point (PSAP), sometimes called a public-safety access point, is a call center where emergency/non-emergency calls (like police, fire brigade, ambulance) are received and handled. The PSAP is a call center in almost all countries, including Canada and the United States, where a trained PSAP operator is typically responsible for answering calls to an emergency telephone number for police, firefighting, and ambulance services. In Canada and the United States, counties are generally bound to provide a PSAP and other emergency services even within municipalities, unless the municipality chooses to opt out and have its own system. Each PSAP has a ‘real’ telephone number that is called when an emergency number (e.g., 911) is dialed or texted. The telecommunications operator is responsible for associating all landline numbers with the most applicable (often the nearest) PSAP, such that when the emergency number is dialed, the call or text is automatically routed to the most suitable PSAP.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A-1C are a simplified block diagrams of a system to enable identification of a harassment communication, in accordance with an embodiment of the present disclosure;

FIG. 2 is a simplified block diagram of a particular implementation of a harassment communication detection engine to help enable identification of a harassment communication, in accordance with an embodiment of the present disclosure;

FIG. 3 is simplified block diagram of a particular implementation of a database used to help enable identification of a harassment communication, in accordance with an embodiment of the present disclosure;

FIG. 4 is a simplified block diagram illustrating example details of a system to help enable identification of a harassment communication, in accordance with an embodiment of the present disclosure;

FIG. 5 is a simplified block diagrams illustrating example details of a system to help enable identification of a harassment communication, in accordance with an embodiment of the present disclosure;

FIGS. 6A-6B are a simplified block diagram illustrating example details of a system to help enable identification of a harassment communication, in accordance with an embodiment of the present disclosure;

FIG. 7 is a simplified flowchart illustrating potential operations to help enable identification of a harassment communication, in accordance with an embodiment of the present disclosure;

FIG. 8 is a simplified flowchart illustrating potential operations to help enable identification of a harassment communication, in accordance with an embodiment of the present disclosure;

FIG. 9 is a simplified flowchart illustrating potential operations to identification of a harassment communication, in accordance with an embodiment of the present disclosure;

FIG. 10 is a simplified flowchart illustrating potential operations to identification of a harassment communication, in accordance with an embodiment of the present disclosure;

FIG. 11 is a simplified flowchart illustrating potential operations to identification of a harassment communication, in accordance with an embodiment of the present disclosure;

FIG. 12 is a simplified block diagram illustrating example details of an example computer model inference and computer model training to help enable identification of a harassment communication, in accordance with an embodiment of the present disclosure; and

FIG. 13 is a simplified block diagram illustrating examples details of an example neural network architecture to enable identification of a harassment communication, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to enabling identification of a harassment communication, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

A public safety answering point (PSAP) can receive multiple communications that are intended to harass a victim or even the PSAP itself. For example, one troubling type of harassment is swatting. The term swatting is derived from the law enforcement unit Special Weapons and Tactics (SWAT), a specialized type of police unit in the United States. Swatting is a criminal harassment act of deceiving an emergency service into sending police, emergency service response team, and/or a SWAT team to a person's address. A swatting is triggered by false reporting of a serious law enforcement emergency, such as a bomb threat, murder, hostage situation, or a false report of a mental health emergency, such as reporting that a person is suicidal or homicidal and may be armed, among other things.

Another type of harassment is a Telephony Denial of Service (TDoS) attack. A TDoS attack is an attempt to overwhelm critical telephone systems, such as PSAP emergency response numbers or call centers and make the telephone system unavailable by preventing incoming and/or outgoing calls. The objective of a TDOS attack is to keep the distracting calls active for as long as possible to overwhelm the victim's telephone system, which may delay or block legitimate calls for service. In addition, harassing communications can disrupt businesses. Harassing calls to a business can include repeated phone calls, calls made in the middle of the night, or calls that include threats or lewd language. In some examples, the communication to the business can seem like a legitimate communication but is intended to harass a victim. For example, several orders for goods or services can be placed for a victim that does not want the goods or services. The business has no way to know the communication is intended to harass the victim. What is needed is a way to identify and prevent or mitigate harassing communications.

In an example, a system, method, apparatus, means, etc. can enable the identification of harassing communications, especially communications to a PSAP. For example, a harassment detection engine can detect when a communication is likely to be a communication intended to harass a victim. In some examples, the harassment detection engine can detect when a communication is likely to be swatting, part of a TDOS attack, nuisance call, or some other type of communication intended to harass a victim. More specifically, the harassment detection engine can be configured to use one or more criteria to analyze the communication and try to determine if the communication is likely to be a communication intended to harass a victim. The one or more criteria can include whether or not the victim is on a known victim list, if the device that initiated the communication is on a known harassment list, the attestation of the phone number that is associated with the communication, if the phone number that is associated with the communication is spoofed, if the communication is a communication to a PSAP on an administrative line instead of the 911 emergency line, the relationship, if it can be determined, of the user that initiated the communication and the victim, the location of the origination of the communication compared to the location of the victim, the type of call, and other criteria.

In some examples the one or more criteria can be weighted. The criteria can be used to create a harassment confidence score, ranking, or other type of indicator assigned to the communication that indicates the likely that the communication is a communication intended to harass the victim. The harassment confidence score can be a multidimensional harassment confidence score that depends on the type of communication (e.g., phone call, text, etc.) and subject of the communication (e.g., reporting of a serious law enforcement emergency, non-PSAP services related communications, etc.). In some examples, different communication types and different subjects of the communication (e.g. a request for emergency services or a SWAT team to respond to an alleged life threatening situation vs. repeated requests for non-emergency services) can have different harassment confidence score thresholds. More specifically, the harassment confidence score can be created differently for each type and subject of the communication, and based on the harassment confidence score, specific rules can be applied (e.g., route a voice call to an interactive voice response system (IVR), flag the communication as a potential harassment communication, etc.). In some examples, computer models, including various types of neural networks and/or large language models (e.g., OpenAI, Llama2, chatbots, etc.), may be trained to identify potential harassment communications.

### Example Systems, Apparatuses, and Methods

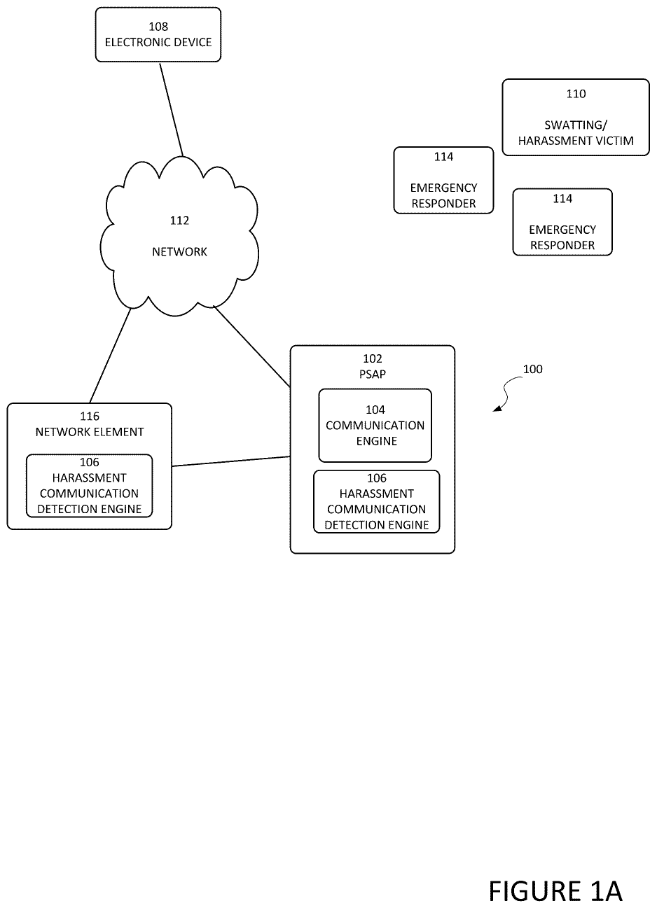

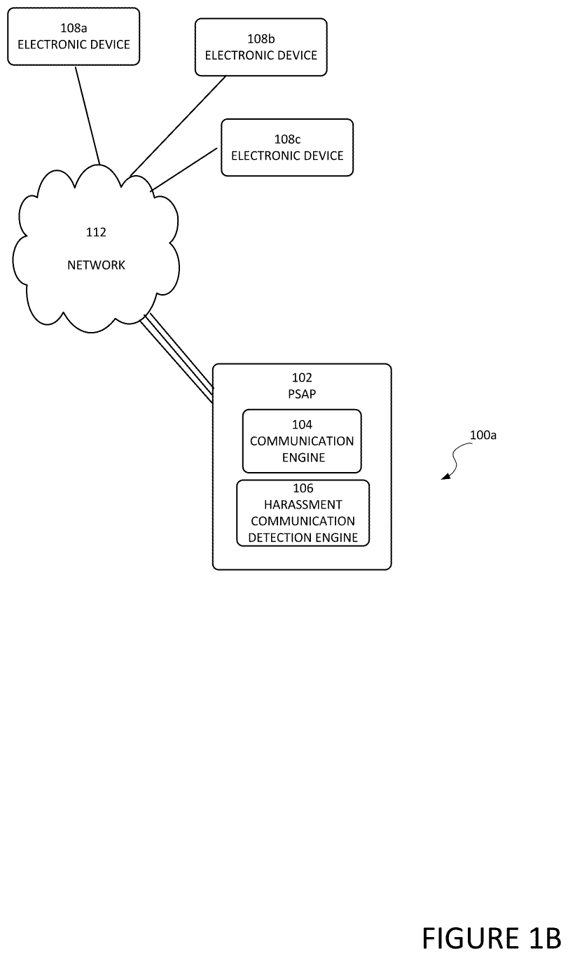

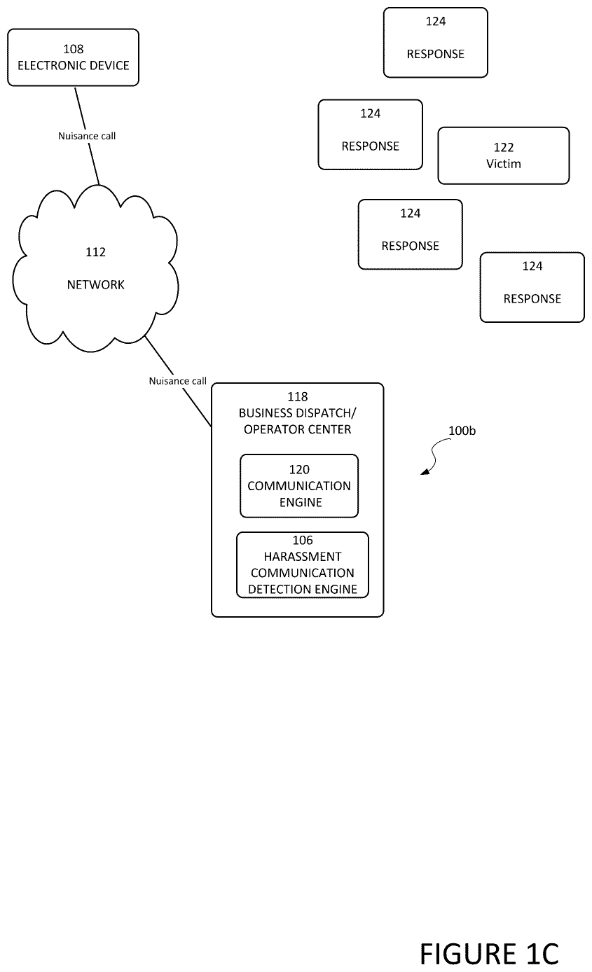

FIG. 1A is simplified block diagram of a particular non-limiting communication system 100 to enable identification of a harassment communication. The communication system 100 can include a PSAP 102. The PSAP can include a communication engine 104 and a harassment communication detection engine 106. In some examples, the harassment communication detection engine 106 is located in a network element 116. The network element 116 may be a server, cloud services, or some other network element. The communication engine 104 helps to facilitate communications to and from the PSAP 102. The harassment communication detection engine 106 can help to detect when a communication is likely to be a communication intended to harass a victim.

For example, as illustrated in FIG. 1A, using network 112, a malicious user may use an electronic device 108 to attempt to initiate a swatting attack on a swatting/harassment victim 110. Because swatting is a criminal act and may violate federal as well as state laws, especially if the swatting/harassment victim 110 is injured or killed, the malicious user will likely try to conceal their identity, conceal the number used to initiate the communication to the PSAP 102, and conceal the identity of the electronic device 108 used communicate the attempted swatting. In addition, it is likely that the electronic device 108 used to initiate the swatting communication is not in the same general area as the swatting/harassment victim 110.

The harassment communication detection engine 106 can be configured to use one or more criteria to analyze the communication and try to determine if the communication is likely to be a communication intended to harass a victim. For example, the swatting/harassment victim 110 may be on an anti-swatting registry or anti-harassment registry that includes people who are susceptible to being swatted. If the electronic device 108 can be identified, the electronic device 108 may be listed on a known harassment device registry or if the malicious user has tried to hid the identity of the electronic device 108, the number used for the communication may be spoofed and not pass attestation. Also, the communication to the PSAP 102 may be on an administrative line instead of the 911 emergency line. In addition, if the electronic device 108 used to initiate the swatting communication is not in the same general area as the swatting/harassment victim 110, the communication may be intended as a harassment communication.

In some examples, if the communication is a voice call, during the voice call, the harassment communication detection engine 106 can obtain additional information related to the communication to the PSAP 102 by analyzing the voice call in real time using real time call analytics to help determine if the communication is intended as a harassment communication. For example, if the malicious user uses an incorrect pronunciation of a street name or provides incorrect information about the area or location of the swatting/harassment victim 110, the communication may be intended as a harassment communication. In addition, if it can be determined, the relationship between the user that initiated the communication and the swatting/harassment victim 110 can be used to identify a harassment communication (e.g., a student attempting to swat a teacher, an online gamer attempting to swat a rival online gamer, etc.). Also, the background noise, the speech of the malicious user (e.g., is the speech or voice of the caller calm or laughing as opposed to panicked or troubled like it should be if the situation was a real emergency), if the voice of the caller is masked, and other call characteristics, features, etc. may be used to help determine if the communication may be intended as a harassment communication. After the communication is analyzed by the harassment communication detection engine 106 using the one or more criteria, a harassment confidence score, ranking, or some other type of indicator can be assigned to the communication that indicates the likely that the communication is a communication intended to harass the swatting/harassment victim 110.

The communication and the harassment confidence score, ranking, or other type of indicator can be sent a human operator at the PSAP 102 for review. In some examples, the communication is sent to the PSAP operator and the harassment confidence score is sent after the communication is received by the PSAP operator. Using the harassment confidence score, ranking, or other type of indicator, the human operator at the PSAP 102 can determine if the communication is likely swatting. In some examples, the human operator may dispatch one or more emergency responders 114 with a warning about the likelihood of a swatting incident to allow the emergency responders 114 to assess the situation with caution rather than using full force when responding to the potential threat. In some examples, a drone may be used to explore the scene to determine if there is an actual threat or if the communication is related to an attempted swatting.

In some examples, if the harassment confidence score, ranking, or other type of indicator that indicates the likely that the communication is a communication intended to harass the swatting/harassment victim 110 satisfies a threshold, the communication may not be sent to the human operator at the PSAP 102. For example, if the harassment confidence score satisfies a threshold, the harassment communication detection engine 106 can use an Interactive Voice Response (IVR) to gain more information about the communication and determine if the communication is related to an attempted swatting. If the communication is determined to be related to an attempted swatting, the harassment communication detection engine 106 can be used to gather as much information regarding the identity of the malicious user and the electronic device 108 as possible and the information can be used by law enforcement to try and identify and capture the malicious user. In some examples, the harassment confidence score, ranking, or other type of indicator assigned to the communication that indicates the likely that the communication is a communication intended to harass the victim is a multidimensional harassment confidence score that depends on the type of communication and the criteria where different communication types have different harassment confidence score thresholds. Also, the harassment confidence score can be created differently for each event and, based on the harassment confidence score, certain rules can be applied (e.g., sent the communication to an IVR or chatbot, etc.).

Turning to FIG. 1B, FIG. 1B is simplified block diagram of a particular non-limiting communication system 100a to enable identification of a harassment communication and in particular, a TDoS attack. The communication system 100a can include the PSAP 102. The PSAP 102 can include the communication engine 104 and the harassment communication detection engine 106. The communication engine 104 helps to facilitate communications to and from the PSAP 102. The harassment communication detection engine 106 can help to detect when a communication is likely to be a communication intended to harass a victim.

For example, as illustrated in FIG. 1B, using network 112, a malicious user may use one or more of electronic devices 108a-108c to attempt to initiate a TDoS attack against the PSAP 102. There are different versions of TDoS attacks and both share a common feature in generating many calls to a destination, which eventually overwhelms the private branch exchange (PBX) or trunk to the PSAP 102 and are intended to shut down telephone service of the PSAP 102. In a centralized TDoS attack, many calls to the PSAP 102 are generated from one source (e.g., the electronic device 108a). With a distributed TDoS attack, many call sources (e.g., electronic devices 108a-108c) generate many calls to the PSAP 102 at the same time.

The harassment communication detection engine 106 can be configured to use one or more criteria to analyze the communications to the PSAP and try to determine if the communication is likely to be a communication intended to be a TDoS attack against the PSAP 102. More specifically, in a centralized attack or robocall pattern, the harassment communication detection engine 106 can be configured to identify calls with common attributes, such as the device used to initiate the call, the number assigned to the device used to initiate the call, etc. When calls with a common attribute reach a threshold, further calls with the common attribute are blocked or diverted to an IVR for a period of time. With a distributed attack, the harassment communication detection engine 106 can determine when a volume of calls reaches a threshold and further calls are diverted to an IVR system for screening. The IVR prompts the caller for a response that will allow a legitimate caller to be connected to a PSAP operator, which the distributed malware cannot provide, to help try and mitigate the distributed TDoS attack. In some examples, crucial lines are moved to a different, temporary PBX in case the PBX itself is targeted or overwhelmed.

Turning to FIG. 1C, FIG. 1C is simplified block diagram of a particular non-limiting communication system 100b to enable identification of a harassment communication, especially harassment of a business or victim by sending unwanted goods or services to the victim. The communication system 100b can include a business dispatch/operator center 118. The business dispatch/operator center 118 can include the communication engine 120 and the harassment communication detection engine 106. The communication engine 120 helps to facilitate communications to and from the business dispatch/operator center 118. The harassment communication detection engine 106 can help to detect when a communication is likely to be a communication intended to harass a victim.

For example, as illustrated in FIG. 1C, using network 112, a malicious user may use an electronic device 108 to attempt to harass a victim 122 using a third-party delivery or response service 124. For example, a malicious user may use the electronic device 108 to request or order multiple deliveries for the victim 122 or request multiple services for the victim. More specifically, the malicious user can request multiple goods or services for the victim 122 with payment expected on delivery of the goods or services. In another example, the malicious user can request multiple services such as house repairs or service calls where multiple service technicians may show up at the victim's residence for a service the victim 122 does not need or want in an attempt to harass the victim 122.

The harassment communication detection engine 106 can be configured to use one or more criteria to analyze the communication and try to determine if the communication is likely to be a communication intended to harass the victim 122. For example, the victim 122 may be on an anti-harassment registry that includes users who are susceptible to being harassed. If the electronic device 108 can be identified, the electronic device 108 may be listed on a known device harassment registry or if the malicious user has tried to hid the identity of the electronic device 108, the number used for the communication may be spoofed and not pass attestation. In some examples, the harassment communication detection engine 106 can obtain additional information during the communication. For example, if the electronic device 108 used to initiate the harassment communication is not in the same general area as the victim 122, the malicious user may use an incorrect pronunciation of a street name or provide incorrect information about the area. Also, if it can be determined, the relationship of the user that initiated the communication and the victim, the location of the origination of the communication compared to the location of the victim, the type of call, and other criteria may be used. After the communication is analyzed by the harassment communication detection engine 106 using the one or more one or more criteria, a harassment confidence score, ranking, or some other type of indicator can be assigned to the communication that indicates the likely that the communication is a communication intended to harass the victim 122.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure. For purposes of illustrating certain example techniques to enable identification of a harassment communication, the following foundational information may be viewed as a basis from which the present disclosure may be properly explained.

A PSAP, sometimes called a public-safety access point, is a call center where emergency/non-emergency calls (like police, fire brigade, ambulance) initiated by any landline, mobile or Voice Over Internet Protocol (“VOIP”) are received. When a communication is sent to a PSAP, a highly trained professional human PSAP operator is expected to respond to the communication. However, PSAP operators are part of an industry under immense pressure because of understaffing and a host of other issues. PSAP centers are struggling with surging call and text volumes, complex compounded emergencies, and insufficient support. Because operators at the PSAPs need to handle each call and text, calls and text to the PSAP that are not related to PSAP services and intended to harass a victim waste precious time of the PSAP operators and prevent the PSAP operators from handling real emergencies. In addition, the trend of swatting is becoming a real concern as some swatting events have led to injury and in at least one case, even death of the swatting victim.

Swatting has been around since the early 2000s and has recently gained popularity as a way to harass a victim. Swatting is not just a harmless prank that wastes public resources. There have been instances where physical harm, including death, of the victim has occurred as a result of swatting. Even in instances where the situation is diffused quickly, the misappropriation of resources can divert emergency services away from a real emergency or crime. Today's swatters use sophisticated techniques such as VPN masking, email masking, ID spoofing, voice changers to conceal their real identities, as well as social engineering schemes, making it challenging to identify an attempted swatting. What is needed is a system, an apparatus, and a method to help enable identification of an attempted swatting. It would be beneficial if the system, apparatus, and method could also help enable identification of a harassment communication to a PSAP, especially TDoS attacks. It would also be beneficial if the system, apparatus, and method could help enable identification of a harassment communication that is intended to harass a victim using an unwitting third party.

A system, method, apparatus, means, etc. to enable identification of a harassment communication can help resolve these issues (and others). In an example, a harassment communication detection engine (e.g., the harassment communication detection engine 106) can help enable identification of a harassment communication. In an illustrative example, an electronic device (e.g., the electronic device 108) can send a PSAP (e.g., the PSAP 102) a text message, a voice call, an audio message, or some other type of communication.

In some examples, where the communication is an attempt to swat a victim, the harassment detection engine can be configured to use one or more criteria to analyze the communication and try to determine if the communication is likely to be a communication intended to swat a victim. In some examples, the communication is analyzed in two phases. The first phase is when the communication is first received by the PSAP and includes criteria that can be determined using data and metadata associated with the communication when the communication is first received by the PSAP. For example, the communication to the PSAP may be on an administrative line or non-emergency line instead of the 911 emergency line, the phone number used for the communication may be spoofed and not pass attestation, etc. The second phase is during the interaction between the PSAP operator, IVR, chat bot, etc. and the user that initiated the communication. For example, during the interaction between the PSAP operator and the user that initiated the communication, the target or intended victim of the swatting communication can be determined and the target or intended victim may be on a known anti-swatting registry or anti-harassment registry that includes users who are susceptible to being swatted or harassed. Also, the user that initiated the communication may be identified and the user that initiated the communication may be included in a known harasser registry. In addition, the location of the electronic device that initiated the communication may not be in the same location as the area of the subject of the communication, or other call characteristics, features, etc. may be used to try to determine if the communication is likely to be a communication intended to swat a victim.

In the second phase, during the interaction between the PSAP operator, IVR, or chatbot and the user that initiated the communication, the harassment communication detection engine 106 can obtain additional information related to the communication to the PSAP. For example, the location of the origination of the communication compared to the location of the victim may be determined and if the location of the user that initiated the communication is not consistent with the location of the victim or subject of the communication, the location of the origination of the communication may indicate an attempted swatting (e.g., the user that initiated the communication may be in Florida while the victim is located in California). Also, if the electronic device used to initiate the swatting communication is not in the same general area as the victim, the user attempting a swatting may use an incorrect pronunciation of a street name or provide incorrect information about the alleged situation. In addition, the relationship of the user that initiated the communication and the victim may be determined and the relationship may indicate an attempted swatting. Further, the type of call, and other criteria, characteristics, features, etc. may be used to analyze the communication and try to determine if the communication is likely to be a communication intended to swat a victim. After the communication is analyzed by the harassment detection engine using the one or more criteria, a harassment confidence score, ranking, or some other type of indicator can be assigned to the communication that indicates the likely that the communication is a communication intended to swat the victim.

In some examples, a harassment confidence score is created for each phase of the two-phase assessment of whether or not the communication is related to harassment. In some examples, the harassment confidence score that was created during the first phase is updated during the second phase. More specifically, during the first phase, the harassment confidence score can be created using data and metadata associated with the communication when the communication is first received at the PSAP 102. The data and metadata can include attestation of the phone number used for the communication, whether the communication was received on an administrative or non-emergency line instead of the 911 emergency line, whether the identity of the electronic device that initiated the can be determined, whether or not the phone number used for the communication is spoofed, and other data and metadata that can be collected when the communication is first received at the PSAP 102. During the second phase, the harassment confidence score can be updated based on data and metadata that is acquired during the communication between the user that initiated the communication and the PSAP operator. For example, the subject of the harassment may be on a registry of known possible victims likely to be harassed, the location of the electronic device that initiated the communication may not be in the same location as the area of the subject of the communication, the background of the communication may be silent, no other communication has been received about the subject of the communication, the user may use incorrect street names when describing the subject of the communication, the voice or mannerisms of the user may not be consistent with the subject of the communication, the relationship of the user that initiated the communication and the victim may indicate a potential harassment communication, and other data and metadata that may be acquired during the communication. In some examples, the harassment confidence score, ranking, or other type of indicator assigned to the communication that indicates the likely that the communication is a communication intended to harass the victim is a multidimensional harassment confidence score that depends on the type of call and the criteria where different call types have different harassment confidence score thresholds. The harassment confidence score can be created differently for each communication and, based on the harassment confidence score, certain rules can be applied. More specifically, the system can determine if the harassment confidence score is above one or more thresholds. For example, for communications where the harassment confidence score is below a first threshold, the communication is not treated as a possible harassment communication. For communications where the harassment confidence score is above a first threshold but below a second threshold, the communication is treated as a possible harassment communication. For communications where the harassment confidence score is above the second threshold, the communication is treated as a harassment communication.

The communication and the harassment confidence score, ranking, or other type of indicator can be sent a human operator at the PSAP for review. In some examples, the communication is sent to the PSAP operator and the harassment confidence score is sent after the communication is received by the PSAP operator. Using the harassment confidence score, ranking, or other type of indicator, the human operator at the PSAP can determine if the communication is likely swatting. In some examples, the human operator may dispatch one or more emergency responders with a warning about the likelihood of a swatting incident to allow the emergency responders to assess the situation with caution rather than using full force when responding to the potential threat. In some examples, a drone may be used to explore the scene to determine if there is an actual threat or if the communication is related to an attempted swatting. In some examples, because the second phase harassment confidence score is being adjusted or redetermined during the communication, the PSAP operator can receive real time updates to the second phase harassment confidence score to help the PSAP operator determine if the communication is a harassment communication, especially a swatting attempt.

In some examples, if the harassment confidence score, ranking, or other type of indicator that indicates the likelihood that the communication is a communication intended to harass the victim is high enough, the communication may not be sent to the human operator at the PSAP. If the communication is determined to be related to an attempted swatting, the communication engine can be used to gather as much information regarding the identity of the user and the electronic device as possible and the information can be used by law enforcement to try and identify and capture the user.

In an example where the communication is part of an attempted TDoS attack, the harassment detection engine can be configured to use one or more criteria to analyze the communication and try to determine if the communication is likely to be a communication intended to be a TDoS attack. For example, in a centralized attack or robocall pattern, the harassment detection engine can be configured to identify calls with common attributes, such as the device used to initiate the call, the number assigned to the device used to initiate the call, etc. When calls with a common attribute reach a threshold, further calls with the common attribute are blocked or diverted to IVR for a period of time. With a distributed attack, the harassment communication detection engine 106 can determine when a volume of calls reaches a threshold and further calls are diverted to an IVR system for screening. The IVR prompts the caller for a response, which the distributed malware cannot provide, to help try and mitigate the distributed TDoS attack. In some examples, crucial lines can be moved to a different, temporary PBX in case the PBX itself is targeted or overwhelmed.

In an example where the communication is part of an attempt to harass a victim using a third-party delivery or response service, a user can request multiple goods or services for the victim with payment expected on delivery of the goods or services. In another example, the user can request multiple services such as house repairs or service calls where multiple service technicians may show up at the victim's residence for a service the victim does not need or want in an attempt to harass the victim.

The harassment detection engine can be configured to use one or more criteria to analyze the communication and try to determine if the communication is likely to be a communication intended to harass the victim. For example, the victim may be on an anti-harassment registry that includes users who are susceptible to being harassed. If the electronic device can be identified, the electronic device may be listed on a known device harassment registry or if the user has tried to hid the identity of the electronic device, the number used for the communication may be spoofed and not pass attestation. In some examples, the harassment communication detection engine 106 can obtain additional information during the communication. For example, if the electronic device used to initiate the harassment communication is not in the same general area as the victim, the user may use an incorrect pronunciation of a street name or provide incorrect information. If it can be determined, the relationship of the user that initiated the communication and the victim, the location of the origination of the communication compared to the location of the victim, the type of call, and other criteria may also be used. After the communication is analyzed by the harassment detection engine using the one or more one or more criteria, a harassment confidence score, ranking, or some other type of indicator can be assigned to the communication that indicates the likely that the communication is a communication intended to harass the victim.

In some examples, the communication is analyzed in two phases. The first phase uses data and metadata associated with the communication when the communication is first received at the PSAP 102. A first phase harassment confidence score can be used to provide an early indication that the communication may be a harassment communication and/or if more information needs to be gathered to determine if the communication is a harassment communication.

A second phase harassment confidence score can be used to help confirm that the communication is a harassment communication. The second phase includes data and metadata that is acquired during the communication between the user and the PSAP operator, IVR, or chat bot. In some examples, because the second phase harassment confidence score is being adjusted or redetermined during the communication between the user and the PSAP operator, the PSAP operator can receive real time updates to the second phase harassment confidence score to help the PSAP operator determine if the communication is a harassment communication.

In some examples, if the first phase harassment confidence score is high enough, the communication may be sent to an IVR where additional details about the communication can be determined. In some examples, just sending the communication to an IVR may be enough to thwart the harassment.

Note that the harassment confidence score for each classification can be any value (e.g., any value between zero (0) and one (1)) or indicator that represents the probability of the communication being a harassment communication, depending on design choice and design constraints. The threshold values should be high enough to avoid emergency communications and non-emergency communications being incorrectly identified as a communication possibly being a harassment communication.

In some examples, additional details related to the communication are determined. More specifically, an IVR execution engine or a text script execution engine (e.g., the text script engine 210) can be used to send one or more questions from a script in a script database (e.g., the IVR scripts 308 or the text scripts 310) to the electronic device that initiated the communication and through the IVR or script, a user of the electronic device can be prompted to provide additional details related to the communication to help determine if the communication is a type of harassment. In some examples, the script execution engine can be a chat bot that engages in a communication to gather more information about the circumstances related to the communication as opposed to strictly following a linear type script. Also, metadata related to the communication can be analyzed to determine additional details related to the communication. In addition, the electronic device can be used (e.g., the camera of the electronic device, the microphone of the electronic device, the GPS of the electronic device, etc.) to determine additional details related to the communication. In some examples, the system can determine if the communication was sent by a human using the electronic device rather than a bot, especially in the case of a TDoS attack. For example, the system can use a prompt (e.g., press “1” to continue, etc.) or some other means to determine if the communication was sent by a human using the electronic device.

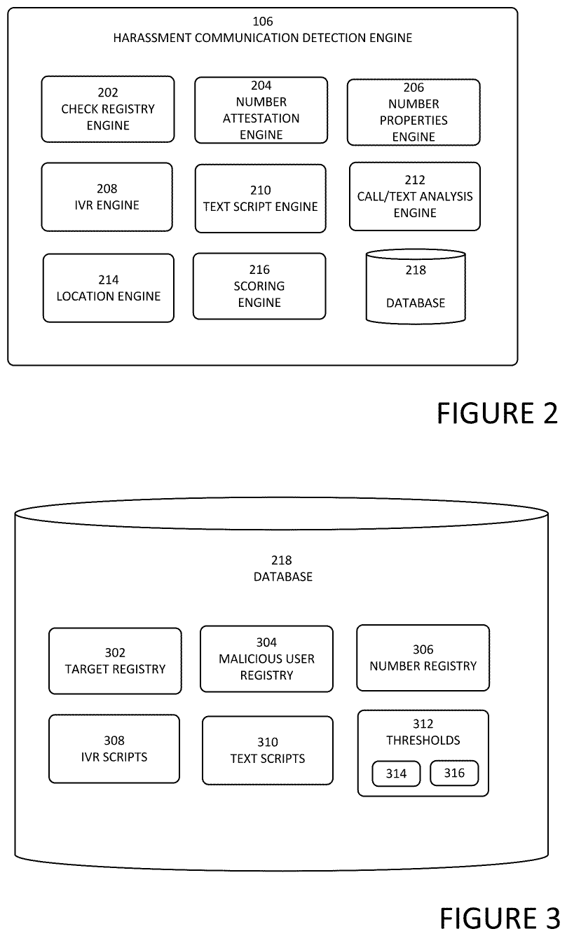

Turning to FIG. 2, FIG. 2 is a simplified block diagram illustrating example details of a particular non-limiting implementation of the harassment communication detection engine 106 of FIGS. 1A-1C. The harassment communication detection engine 106 can include a check registry engine 202, a number attestation engine 204, a number properties engine 206, an IVR engine 208, a text script engine 210, a call/text analysis engine 212, a location engine 214, a scoring engine 216, and a database 218. The database 218 is explained in more detail with reference to FIG. 3. In some examples, one or more of the check registry engine 202, the number attestation engine 204, the number properties engine 206, the IVR engine 208, the text script engine 210, the call/text analysis engine 212, the location engine 214, the scoring engine 216, and the database 218 are located in a server, cloud, network element, and are in communication with the PSAP 102 using network 112 or some other network.

The check registry engine 202 can be configured to search one or more anti-swatting registries and/or anti-harassment registries to determine if a victim is listed on an anti-swatting registry and/or an anti-harassment registry. Some users, celebrities, controversial figures, streamers, etc. are especially prone to being swatted and/or harassed. These users that are prone to being swatted and/or harassed can request their name and/or home address to be included on an anti-swatting registry and/or an anti-harassment registry.

Also, the check registry engine 202 can be configured to search one or more known malicious user registries to determine if a user is listed on a malicious user registry. Some malicious users are serial swatters or serial harassers. In addition, the check registry engine 202 can be configured to search one or more know malicious device registries to determine if the electronic device that initiated the communication is listed on a malicious device registry. Non-service initialized mobile phones can still be used to make calls, and in some examples text, 911. The communication to the PSAP does not show a phone number and instead, the number is listed as 911 plus the last 7 digits of the serial number or International Mobile Equipment Identity (IMEI) of the unregistered phone. The IMEI is a 15-digit identification number unique to the phone. Because the phone is non-service initialized, the ability of the phone to make call or text cannot be turn off. For this reason, non-service initialized phones are often used for swatting. After a non-service initialized phone has been used in swatting or for harassment, the IMEI of the non-service initialized phone can be added to the malicious device registry.

The number attestation engine 204 can be configured to read the attestation level assigned to a communication. Call attestation is a process that verifies a caller's legitimacy. It is a key part of the Stir/Shaken standards, which are protocols created by the Federal Communications Commission (FCC). The Stir/Shaken attestation levels were developed as part of the Stir/Shaken telecom protocol which was implemented in response to the increasing problem of robocalls and caller ID spoofing. To combat this issue, Stir/Shaken attestation verifies the degree to which the originating telecom carrier knows the caller/customer (KYC) and if the telecom carrier knows the caller/customer has authorization to use the Caller ID number they are inserting into the meta data of the call. There are three Stir/Shaken attestation levels, “A”, “B”, and “C”. The level A-attestation is full attestation and indicates that the telecom carrier that originated the call knows the caller/customer that initiated the call and the caller/customer is authorized to use the Caller ID that was used to originate the call. The level B-attestation is partial attestation and indicates that the telecom carrier that originated the call knows the caller/customer that initiated the call but does not have a letter of authorization (LOA) indicating that the caller/customer is authorized to use the Caller ID that was used to originate the call. The level C-attestation is a gateway attestation and means that the telecom carrier does not know the caller's identity and the source of the call cannot be identified. This simply means that the call has been routed through a gateway that is Stir/Shaken compliant. Calls with this level of attestation are most likely to be blocked or tagged as spam. These three levels of attestation indicate the level of confidence the carrier has about the caller's identification.

The number properties engine 206 can be configured to determine one or more properties or characteristics of the communication. For example, the number properties engine 206 can determine if the communication was received on an administrative line rather than the emergency 911 line, if the electronic device 108 is a mobile phone, a non-service initialized mobile phone, a VOIP communication, spoofed number, etc.

The IVR engine 208 can be configured to automatically (without direct human intervention) interact with a caller through voice or touch-tone inputs to determine the purpose of a call through a series of automated questions and answers. In some examples, the IVR engine 208 is a computer model or large language model. The text script engine 210 can be configured to automatically (without direct human intervention) interact with a texter through text or touch-tone inputs to determine the purpose of a text through a series of automated questions and answers. In some examples, the text script engine 210 is a chatbot or large language model.

The call/text analysis engine 212 can be configured to detect irregularities such as the mispronunciation of street names, wrong cross streets, or other irregularities that may suggest a call or text is from a malicious user. The location engine 214 can be configured to determine a location of the user. For example, the location engine 214 may use metadata associated with the communication to determine if the user is in the area that is the subject of the communication (e.g., in a swatting attempt, a caller from outside of the United States may report a fake emergency within the United States in the hopes a SWAT team will be dispatched to the fake emergency).

The scoring engine 216 uses the results from the check registry engine 202, the number attestation engine 204, the number properties engine 206, the answers to questions from the IVR engine 208 and the text script engine 210, the information from the call/text analysis engine 212, and the location, if any, determined by the location engine 214 to determine a harassment confidence score that indicates the likelihood that the communication is a communication intended for harassment. The likelihood of harassment confidence score can be a number between zero (0) and one (1) that represents the likelihood that the communication intended for harassment. The higher the harassment confidence score, the more likely the communication is intended for harassment. Note that other means can be used to indicate the likelihood that the communication is intended for harassment (e.g., color coded flags, letters, percentages, etc.). In some examples the one or more criteria can be weighted. In some examples, the harassment confidence score is a multidimensional harassment confidence score that depends on the nature of the communication (e.g., a communication requesting a SWAT team, a non-emergency communication, a not related to PSAP services communication, etc.) and the criteria where different call types have different harassment confidence score thresholds. The harassment confidence score can be created differently for each event. In some examples, computer models, including various types of neural networks and/or large language models (e.g., OpenAI, Llama2, chatbots, etc.), may be trained to identify potential harassment communications. A human PSAP operator, the communication engine 120, or some other human or computer system can analyze the likelihood of harassment confidence score and make a determine about whether or not the communication is or may be intended for harassment.

Turning to FIG. 3, FIG. 3 is a simplified block diagram illustrating example details of a particular non-limiting implementation of the database 218. The database 218 can include a target registry 302, a malicious user registry 304, a number registry 306, IVR scripts 308, text scripts 310, and thresholds 312.

The target registry 302 can include a list of users that are on one or more anti-swatting registries and/or anti-harassment registries. The target registry 302 can be periodically updated (e.g., every hour, half-day, day, week, etc.) using one or more anti-swatting registries and/or anti-harassment registries to ensure the target registry 302 is up to date. The malicious user registry 304 can include a list of known malicious users linked to harassing communications. The malicious user registry 304 can be periodically updated (e.g., every hour, half-day, day, week, etc.) using one or more malicious user registries to ensure the malicious user registry 304 is up to date. The number registry 306 can include a list of know malicious devices linked to harassing communications. The number registry 306 can be periodically updated (e.g., every hour, half-day, day, week, etc.) using one or more malicious device registries to ensure the number registry 306 is up to date. The check registry engine 202 (illustrated in FIG. 2) can use the target registry 302 to determine if a victim is listed on an anti-swatting registry and/or an anti-harassment registry, the malicious user registry 304 to determine if the communication was initialed by a serial swatters or serial harassers, and the number registry 306 to determine if an electronic device 108 has been previously used to send harassing communications. In some examples, one or more of the target registry 302, the malicious user registry 304, and the number registry 306 are not located in the database 218 and instead, one or more of the target registry 302, the malicious user registry 304, and the number registry 306 are located in a server, cloud, or other network device and the check registry engine 202 can use the network 112 or some other network to access the target registry 302, the malicious user registry 304, and the number registry 306.

The IVR scripts 308 includes one or more scripts that may be used to gather more information about the communication and the malicious user. For example, if the communication is a phone call or voice communication, the IVR engine 208 can use one or more scripts in the IVR scripts 308 to gather more information about the communication and the malicious user to help determine if the communication is a harassment communication. The text scripts 310 includes one or more scripts that may be used to gather more information about the communication and the malicious user. For example, if the communication is a text message, the text script engine 210 (illustrated in FIG. 2) can use one or more scripts in the text scripts 310 to gather more information about the communication and the malicious user to help determine if the communication is a harassment communication.

The scripts in the IVR scripts 308 and the text scripts 310 can be in different languages to match the language of the communication (e.g., if the communication was a text in Spanish, questions to the user based on the script from the IVR scripts 308 or text scripts 310 will be in Spanish). For example, if a received text message or text of an audio communication from the electronic device 108 is in Spanish, then the questions or statements generated by the text script engine 210 can be in Spanish. In some examples, the IVR scripts 308 are not located in the database 218 and instead are located in a server, cloud, or other network device and the IVR engine 208 can use the network 112 or some other network to access the IVR scripts 308. Also, in some examples, the text scripts 310 are not located in the database 218 and instead are located in a server, cloud, or other network device and the text script engine 210 can use the network 112 or some other network to access the text scripts 310.

In some examples, the script from the IVR scripts 308 and the text scripts 310 are linear scripts where one or more questions and/or one or more statements are communicated to the electronic device 108 that initialed the communication. In other examples, the script from the IVR scripts 308 and the text scripts 310 are a guide or outline that is used to gather more information about the circumstances related to the communication. More specifically, the text script engine 210 can be a chat bot that uses scripts as a guide to engage in a communication to gather more information about the circumstances related to the communication as opposed to strictly following a linear type script.

Thresholds 312 can include one or more thresholds to help determine if the communication is a communication intended to harass a victim. For example, the thresholds 312 can include a first phase threshold 314 and a second phase threshold 316. In some examples, if the first phase harassment confidence score is higher than the first phase threshold 314, the communication may be sent to an IVR where additional details about the communication can be determined. In some examples, just by sending the communication to an IVR may be enough to thwart the harassment.

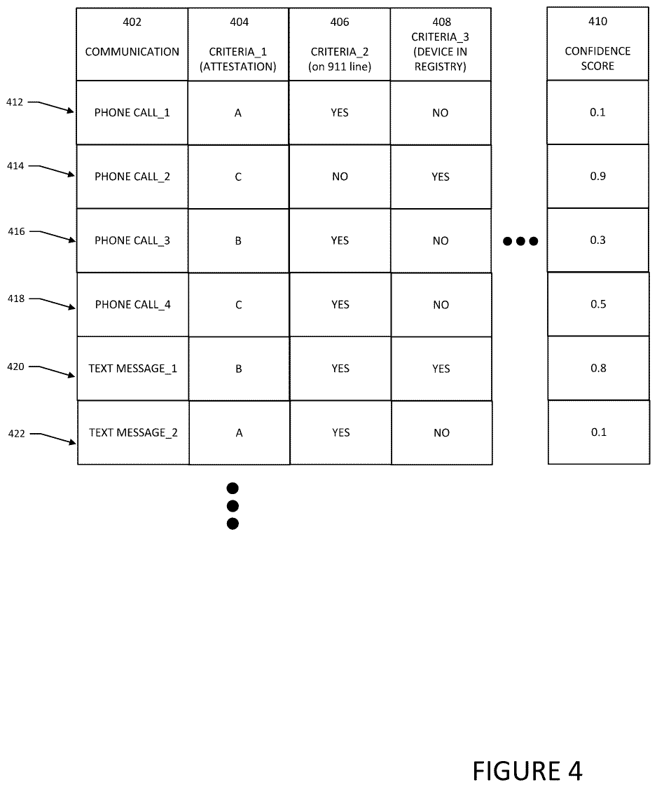

Turning to FIG. 4, FIG. 4 is a simplified block diagram illustrating specific example details to help enable identification of a harassment communication. In an example, using one or more criteria, a first phase harassment confidence score 410 (e.g., a first phase harassment confidence score), ranking, or some other type of indicator can be assigned to a communication that indicates the likelihood that the communication is a communication intended to harass a user (e.g., the swatting/harassment victim 110). For example, as illustrated in FIG. 4, when a communication 402 is received, the harassment communication detection engine 106 can use first phase criteria_1 404, first phase criteria_2 406, and first phase criteria_3 408 to create the first phase harassment confidence score 410, ranking, or some other type of indicator assigned to the communication that indicates the likelihood that the communication is a communication intended to harass a user. In some examples, the first phase criteria_1 404, first phase criteria_2 406, and first phase criteria_3 408 are first phase criteria. The first phase criteria_1 404, first phase criteria_2 406, and first phase criteria_3 408 are first phase criteria because the information needed for each criteria requires details that are typically available when the communication is first received at a PSAP and the harassment communication detection engine 106 can determine the first phase harassment confidence score 410 without causing significantly delayed of the communication from being received by the PSAP operator (e.g., less than a 5 second delay, a 10 second delay, a 15 second delay, a 20 second delay, or a 30 second delay).

Note that the first phase criteria_1 404, the first phase criteria_2 406, and the first phase criteria_3 408 are only example criteria and more criteria may be used, fewer criteria may be used, and/or different criteria may be used. In some examples, machine learning is used to create the first phase harassment confidence score 410, ranking, or some other type of indicator can be assigned to the communication that indicates the likely that the communication is a communication intended to harass a user (e.g., the swatting/harassment victim 110). The communication and the first phase harassment confidence score 410, ranking, or other type of indicator can be sent a human operator at the PSAP 102 for review. Using the first phase harassment confidence score 410, ranking, or other type of indicator, the human operator at the PSAP 102 can determine if the communication is likely a harassment communication.

As illustrated in FIG. 4, the first phase harassment confidence score 410 is a number between zero (0) and one (1) that represents the likelihood that the communication is a harassment communication. The higher the first phase harassment confidence score 410, the more likely the communication is a harassment communication. Note that other means can be used to indicate the likelihood that the communication is a harassment communication. Also, one or more other criteria may be used to help create the first phase harassment confidence score 410.

In an illustrative example, when a communication is received by the PSAP, the harassment communication detection engine 106 can analyze the communication using attestation as the criteria_1 604, one or more properties or characteristics of the communication as the criteria_2 606, and whether or not the device that initiated the communication is in a known device harassment registry as the criteria_3 608. For example, as indicated by row 412, phone call_1 was received and analyzed by the harassment communication detection engine 106. More specifically, for the criteria_1 604, the number attestation engine 204 was used to check the attestation level assigned to the number used for the phone call_1 and determined that the level A-attestation was assigned. For the criteria_2 606, the number properties engine 206 was used to determine one or more properties or characteristics of the phone call_1 and determined that the phone call_1 was received on an emergency 911 line rather than an administrative line. For the criteria_3 608, the check registry engine 202 was used to determine if the electronic device that initiated the phone call_1 is listed in a known malicious device registry and determined that the electronic device used for the phone call_1 is not listed in a malicious device registry. More specifically, the check registry engine 202 can use the number registry 306 to determine if an electronic device 108 has been previously used to send harassing communications. Based on the number used for the phone call_1 having level A-attestation, the phone call_1 being received on the 911 emergency line, and the electronic device that initiated the phone call_1 not on a malicious device registry, the harassment communication detection engine 106 assigned the phone call_1 a 0.1 as the first phase harassment confidence score 410 meaning that it is unlikely the phone call_1 is a harassment communication.

In contrast, as indicated by row 414, phone call_2 was received and analyzed by the harassment communication detection engine 106. More specifically, for the criteria_1 604, the number attestation engine 204 was used to check the attestation level assigned to the number used for the phone call_2 and determined that the attestation level C-attestation was assigned. For the criteria_2 606, the number properties engine 206 was used to determine one or more properties or characteristics of the phone call_2 and determined that the phone call_2 was received on an administrative line rather than 911 emergency line. For the criteria_3 608, the check registry engine 202 was used to determine if the electronic device that initiated the phone call_2 is listed in a known malicious device registry and determined that the electronic device used for the phone call_2 is listed in a malicious device registry. Based on the number used for the phone call_2 having a level C-attestation, the phone call_2 being received on an administrative line and not the 911 emergency line, and the electronic device that initiated the phone call_2 being on a malicious device registry, the harassment communication detection engine 106 assigned the phone call_2 a 0.9 as the first phase harassment confidence score 410 meaning that it is likely the phone call_2 is a harassment communication and the PSAP operator should exercise caution when handling the phone call_2. In some examples, due to the phone call_2 being assigned a 0.9 as the first phase harassment confidence score 410, the phone call_2 may be routed to an IVR to try and obtain more information about the reason for the phone call_2 and to thwart or stop the harassment communication.

As indicated by row 416, phone call_3 was received and analyzed by the harassment communication detection engine 106. More specifically, for the criteria_1 604, the number attestation engine 204 was used to check the attestation level assigned to the number used for the phone call_3 and determined that the level B-attestation was assigned. For the criteria_2 606, the number properties engine 206 was used to determine one or more properties or characteristics of the phone call_3 and determined that the phone call_3 was received on the 911 emergency line. For the criteria_3 608, the check registry engine 202 was used to determine if the electronic device that initiated the phone call_3 is listed in a known malicious device registry and determined that the electronic device used for the phone call_3 is not listed in a malicious device registry. Based on the number used for the phone call_3 having a level B-attestation, the phone call_3 being received on the 911 emergency line, and the electronic device that initiated the phone call_2 not being on a malicious device registry, the harassment communication detection engine 106 assigned the phone call_3 a 0.3 as the first phase harassment confidence score 410 meaning that it is unlikely the phone call_3 is a harassment communication.

As indicated by row 418, phone call_4 was received and analyzed by the harassment communication detection engine 106. More specifically, for the criteria_1 604, the number attestation engine 204 was used to check the attestation level assigned to the number used for the phone call_4 and determined that the level C-attestation was assigned. For the criteria_2 606, the number properties engine 206 was used to determine one or more properties or characteristics of the phone call_4 and determined that the phone call_4 was received on the 911 emergency line. For the criteria_3 608, the check registry engine 202 was used to determine if the electronic device that initiated the phone call_4 is listed in a known malicious device registry and determined that the electronic device used for the phone call_4 is not listed in a malicious device registry. Based on the number used for the phone call_4 having a level C-attestation, the phone call_4 being received on the 911 emergency line, and the electronic device that initiated the phone call_4 not being on a malicious device registry, the harassment communication detection engine 106 assigned the phone call_4 a 0.5 as the first phase harassment confidence score 410 meaning that the phone call_4 could be a harassment communication.

As indicated by row 420, text message_1 was received and analyzed by the harassment communication detection engine 106. More specifically, for the criteria_1 604, the number attestation engine 204 was used to check the attestation level assigned to the number used for the text message_1 and determined that the level B-attestation was assigned. For the criteria_2 606, the number properties engine 206 was used to determine one or more properties or characteristics of the text message_1 and determined that the text message_1 was received on the emergency text-to-911 line. For the criteria_3 608, the check registry engine 202 was used to determine if the electronic device that initiated the text message_1 is listed in a known malicious device registry and determined that the electronic device used for the text message_1 is listed in a malicious device registry. Based on the number used for the text message_1 having a level B-attestation, the text message_1 being received on the emergency text-to-911 line, and the electronic device that initiated the text message_1 being on a malicious device registry, the harassment communication detection engine 106 assigned the text message_1 a 0.8 as the first phase harassment confidence score 410 meaning that the text message_1 is likely to be a harassment communication. In some examples, due to the text message_1 being assigned a 0.8 as the first phase harassment confidence score 410, the text message_1 may be routed to a chat bot to obtain more information about the reason for the text message_1 and to try and thwart or stop the harassment communication.

As indicated by row 422, text message_2 was received and analyzed by the harassment communication detection engine 106. More specifically, for the criteria_1 604, the number attestation engine 204 was used to check the attestation level assigned to the number used for the text message_2 and determined that the level A-attestation was assigned. For the criteria_2 606, the number properties engine 206 was used to determine one or more properties or characteristics of the text message_2 and determined that the text message_2 was received on the emergency text-to-911 line. For the criteria_3 608, the check registry engine 202 was used to determine if the electronic device that initiated the text message_2 is listed in a known malicious device registry and determined that the electronic device used for the text message_2 is not listed in a malicious device registry. Based on the number used for the text message_2 having a level A-attestation, the text message_2 being received on the emergency text-to-911 line, and the electronic device that initiated the text message_2 not being on a malicious device registry, the harassment communication detection engine 106 assigned the text message_2 a 0.1 as the first phase harassment confidence score 410 meaning that the text message_2 is not likely to be a harassment communication.

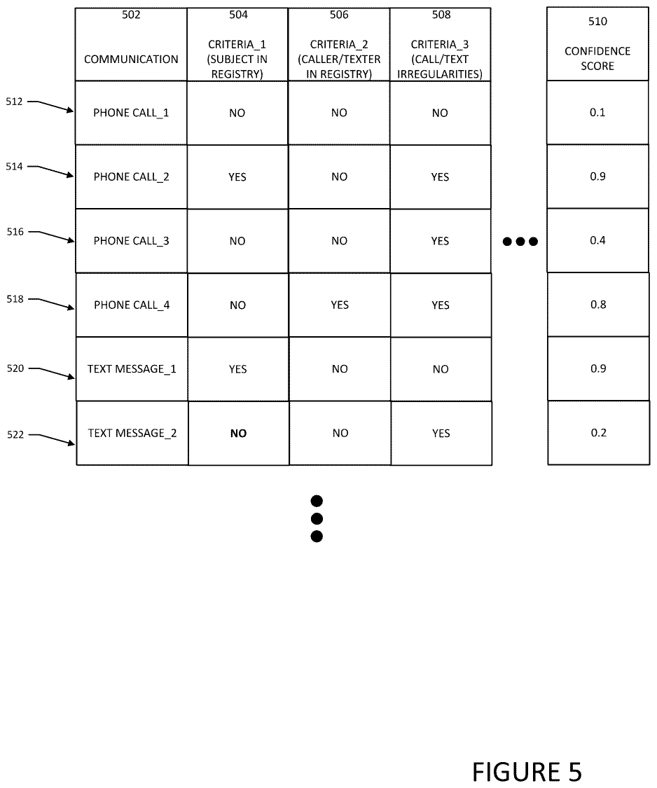

Turning to FIG. 5, FIG. 5 is a simplified block diagram illustrating specific example details to help enable identification of a harassment communication. In an example, using one or more criteria a second phase harassment confidence score 510 (e.g., a second phase harassment confidence score), ranking, or some other type of indicator can be assigned to the communication that indicates the likelihood that the communication is a communication intended to harass a user (e.g., the swatting/harassment victim 110). For example, as illustrated in FIG. 5, when a communication 502 is received, the harassment communication detection engine 106 can use second phase criteria_1 504, second phase criteria_2 506, and second phase criteria_3 508 to create the second phase harassment confidence score 510, ranking, or some other type of indicator can be assigned to the communication that indicates the likely that the communication is a communication intended to harass a user. In some examples, the second phase criteria_1 504, second phase criteria_2 506, and second phase criteria_3 508 are second phase criteria. The second phase criteria_1 504, second phase criteria_2 506, and second phase criteria_3 508 are second phase criteria because the information needed for each criteria requires details that are not typically available when the communication is first received or if the information is received, it may take time to process the information which would delay the communication from being received by the PSAP operator (e.g., more than a 30 second delay).

Note that the second phase criteria_1 504, the second phase criteria_2 506, and the second phase criteria_3 508 are only example criteria and more criteria may be used, fewer criteria may be used, and/or different criteria may be used. In some examples, machine learning is used to create the second phase harassment confidence score 510, ranking, or some other type of indicator can be assigned to the communication that indicates the likely that the communication is a communication intended to harass a user (e.g., the swatting/harassment victim 110). The communication and the second phase harassment confidence score 510, ranking, or other type of indicator can be sent a human operator at the PSAP 102 for review. Using the second phase harassment confidence score 510, ranking, or other type of indicator, the human operator at the PSAP 102 can determine if the communication is likely a harassment communication.

As illustrated in FIG. 5, the second phase harassment confidence score 510 is a number between zero (0) and one (1) that represents the likelihood that the communication is a harassment communication. The higher the second phase harassment confidence score 510, the more likely the communication is a harassment communication. Note that other means can be used to indicate the likelihood that the communication is a harassment communication. Also, one or more other criteria may be used to help create the second phase harassment confidence score 510.

In an illustrative example, when a communication is received by the PSAP, the harassment communication detection engine 106 can analyze the communication using whether or not the subject of the communication is included in an anti-harassment registry as the second phase criteria_1 504, whether or not the caller/texter is included in a known harasser registry as the second phase criteria_2 506, and whether or not the communication includes any irregularities as the second phase criteria_3 508. For example, as indicated by row 512, during the second phase, phone call_1 was received and analyzed by the harassment communication detection engine 106. More specifically, for the second phase criteria_1 504, the check registry engine 202 was used to determine if the subject of the communication is included in an anti-harassment registry and the subject was not included in an anti-harassment registry. The details about the subject, or target, of the communication may not be clear when the communication is received by the PSAP and, rather than wait for ten (10) seconds, fifteen (15) seconds, twenty (20) seconds, or thirty (30) seconds or more for an IVR to obtain the subject or target of the communication and then forward the communication to a PSAP operator, the criteria of whether or not the subject or target of the communication is included in an anti-harassment registry can be a second phase criteria. For the second phase criteria_2 506, the check registry engine 202 was used to determine if the user that initiated the communication is included in a known harasser registry and determined that the user that initiated the communication is not included in a known harasser registry. The details about the user that initiated the communication may not be clear when the communication is received by the PSAP and, rather than wait for ten (10) seconds, fifteen (15) seconds, twenty (20) seconds, or thirty (30) seconds or more to obtain the identity of the user that initiated the communication and then forward the communication to a PSAP operator, the criteria of whether or not the user that initiated the communication is included in a known harasser registry can be a second phase criteria.

For the second phase criteria_3 508, the call/text analysis engine 212 was used to determine if the communication included any irregularities and determined that the communication did not include any irregularities. The irregularities can include a mispronounced street name or incorrect information about the area, no background noise or suspicious background noise, the communication being the only communication about an event where there should be multiple communications (e.g., an active shooter would cause multiple calls to be sent to the PSAP), the voice or mannerisms of the malicious user may not be consistent with the subject of the communication, and other irregularities that may indicate if the call is a harassment communication and not a legitimate communication about an emergency or event. Based on the subject of the communication not being included in an anti-harassment registry, the caller/texter not being included in a known harasser registry, and the communication not including any irregularities, the harassment communication detection engine 106 assigned the phone call_1 a 0.1 as the second phase harassment confidence score 510 meaning that it is unlikely the phone call_1 is a harassment communication. The second phase harassment confidence score 510 assigned to the phone call_1 is the same low assigned first phase harassment confidence score 410 assigned to the phone call_1 in row 412 of FIG. 4 and the PSAP operator can be relatively confident that the phone call_1 is not a harassment communication.

In contrast, as indicated by row 514, phone call_2 was received and analyzed by the harassment communication detection engine 106. More specifically, for the second phase criteria_1 504, the check registry engine 202 was used to determine if the subject of the communication is included in an anti-harassment registry and the subject was included in an anti-harassment registry. For example, the phone call_2 may be an attempt to swat a famous actor, a political figure, or some controversial figure that has registered themselves on an anti-harassment registry. For the second phase criteria_2 506, the check registry engine 202 was used to determine if the user that initiated the communication is included in a known harasser registry and determined that the user that initiated the communication is included in a known harasser registry. For example, the user that initiated the communication may be a user that is known to have initiated harassment communications before. For the second phase criteria_3 508, the call/text analysis engine 212 was used to determine if the communication included any irregularities and determined that the communication did include irregularities. For example, during the phone call_2, the user may have mispronounced a street name or provide incorrect information about the area where the subject of the communication is located, the phone call-2 does not include any background noise or includes suspicious background noise, and/or other irregularities that may indicate the call is a harassment communication and not a legitimate communication about an emergency or event. Based on the subject of the communication being included in an anti-harassment registry, the caller/texter being included in a known harasser registry, and the communication including irregularities, the harassment communication detection engine 106 assigned the phone call_2 a 0.9 as the second phase harassment confidence score 510 meaning that it is likely the phone call_2 is a harassment communication. The second phase harassment confidence score 510 assigned to the phone call_2 is the same high assigned second phase harassment confidence score 510 assigned to the phone call_2 in row 414 of FIG. 4 and the PSAP operator can be relatively confident that the phone call_2 is a harassment communication and the PSAP operator should exercise caution when handling the phone call_2. In some examples, due to the phone call_2 being assigned a 0.9 as the first phase harassment confidence score 410, the phone call_2 may have been routed to an IVR to try and obtain more information about the reason for the phone call_2 and based on the additional information, the phone call_2 was assigned a 0.9 as the second phase harassment confidence score 510. Because both the first phase harassment confidence score 410 (the first phase confidence score) and the second phase harassment confidence score 510 (the second phase confidence score) assigned to the phone call_2 were 0.9, the call may be dropped and/or reported to law enforcement.

As indicated by row 516, phone call_3 was received and analyzed by the harassment communication detection engine 106. More specifically, for the second phase criteria_1 504, the check registry engine 202 was used to determine if the subject of the communication is included in an anti-harassment registry and the subject was not included in an anti-harassment registry. For the second phase criteria_2 506, the check registry engine 202 was used to determine if the user that initiated the communication is included in a known harasser registry and determined that the user that initiated the communication is not included in a known harasser registry. For the second phase criteria_3 508, the call/text analysis engine 212 was used to determine if the communication included any irregularities and determined that the communication did include irregularities. Based on the subject of the communication not being included in an anti-harassment registry, the caller/texter not being included in a known harasser registry, and the communication including irregularities, the harassment communication detection engine 106 assigned the phone call_3 a 0.4 as the second phase harassment confidence score 510 meaning that the phone call_3 could be a harassment communication. The second phase harassment confidence score 510 assigned to the phone call_3 is slightly higher than the 0.3 assigned first phase harassment confidence score 410 assigned to the phone call_2 in row 416 of FIG. 4 and the PSAP operator can be alerted to exercise caution when handling the phone call_3 as some of the criteria suggest the communication may be a harassment communication and perhaps obtain additional information to try and determine if the communication is a harassment communication.

As indicated by row 518, phone call_4 was received and analyzed by the harassment communication detection engine 106. More specifically, for the second phase criteria_1 504, the check registry engine 202 was used to determine if the subject of the communication is included in an anti-harassment registry and the subject was not included in an anti-harassment registry. For the second phase criteria_2 506, the check registry engine 202 was used to determine if the user that initiated the communication is included in a known harasser registry and determined that the user that initiated the communication is included in a known harasser registry. For the second phase criteria_3 508, the call/text analysis engine 212 was used to determine if the communication included any irregularities and determined that the communication did include irregularities. Based on the subject of the communication not being included in an anti-harassment registry, the caller/texter being included in a known harasser registry, and the communication including irregularities, the harassment communication detection engine 106 assigned the phone call_4 a 0.8 as the second phase harassment confidence score 510 meaning that the phone call_4 could be a harassment communication. The second phase harassment confidence score 510 assigned to the phone call_4 is higher than the 0.5 assigned first phase harassment confidence score 410 assigned to the phone call_4 in row 418 of FIG. 4 and the PSAP operator can be alerted to exercise caution when handling the phone call_4 as some of the criteria suggest the communication is a harassment communication.

As indicated by row 520, text message_1 was received and analyzed by the harassment communication detection engine 106. More specifically, for the second phase criteria_1 504, the check registry engine 202 was used to determine if the subject of the communication is included in an anti-harassment registry and the subject was included in an anti-harassment registry. For the second phase criteria_2 506, the check registry engine 202 was used to determine if the user that initiated the communication is included in a known harasser registry and determined that the user that initiated the communication is not included in a known harasser registry. For the second phase criteria_3 508, the call/text analysis engine 212 was used to determine if the communication included any irregularities and determined that the communication did not include irregularities. Based on the subject of the communication being included in an anti-harassment registry, the caller/texter not being included in a known harasser registry, and the communication not including irregularities, the harassment communication detection engine 106 assigned the text message_1 a 0.9 as the second phase harassment confidence score 510 meaning that it is likely the text message_1 is a harassment communication. Note that some of the criteria can be weighted such that only criteria_1 indicated the communication may be a harassment communication and the relatively high second phase harassment confidence score 510 of 0.9 (meaning likely to be a harassment communication) is due to the subject being included in an anti-harassment registry. The second phase harassment confidence score 510 assigned to the text message_1 is the slightly higher than the second phase harassment confidence score 510 assigned to the text message_1 in row 420 of FIG. 4 and the PSAP operator can be relatively confident that the text message_1 is a harassment communication and the PSAP operator should exercise caution when handling the text message_1. In some examples, due to the text message_1 being assigned a 0.8 as the first phase harassment confidence score 410, the text message_1 may have been routed to a chat bot to try and obtain more information about the reason for the text message_1 and based on the additional information, the text message_1 was assigned a 0.9 as the second phase harassment confidence score 510. Because both the first phase harassment confidence score 410 (the first phase confidence score) and the second phase harassment confidence score 510 (the second phase confidence score) assigned to the text message_1 were relatively high (0.8 and 0.9 respectively), the text may be dropped and/or reported to law enforcement.

As indicated by row 522, text message_2 was received and analyzed by the harassment communication detection engine 106. More specifically, for the second phase criteria_1 504, the check registry engine 202 was used to determine if the subject of the communication is included in an anti-harassment registry and the subject was not included in an anti-harassment registry. For the second phase criteria_2 506, the check registry engine 202 was used to determine if the user that initiated the communication is included in a known harasser registry and determined that the user that initiated the communication is not included in a known harasser registry. For the second phase criteria_3 508, the call/text analysis engine 212 was used to determine if the communication includes any irregularities and determined that the communication did include irregularities. For example, in the text message_2, the user may have a misspelled a street name or provide incorrect information about the area around the subject of the communication, and/or other irregularities that may indicate the text is a harassment communication and not a legitimate communication about an emergency or event. Note that for text messages, the criteria that the communication includes any irregularities can be weighted less than other criteria due to the nature of text messages and words in the text message often being misspelled, especially in an emergency situation. Based on the subject of the communication not being included in an anti-harassment registry, the caller/texter not being included in a known harasser registry, and the communication including irregularities, the harassment communication detection engine 106 assigned the text message_2 a 0.2 as the second phase harassment confidence score 510 meaning that it is likely the text message_2 is not a harassment communication. The second phase harassment confidence score 510 of 0.2 assigned to the text message_2 is slightly higher than the assigned first phase harassment confidence score 410 assigned to the text message_2 in row 422 in FIG. 4 and the PSAP operator can be relatively confident that the text message_2 is not a harassment communication.

Note that in row 516, the phone call_3 had similar attributes to the text message_2 where the subject of the communication was not included in an anti-harassment registry, the caller/texter was not included in a known harasser registry, and the communication including irregularities and the harassment communication detection engine 106 assigned the phone call_3 a 0.4 as the second phase harassment confidence score 510. The call/text analysis engine 212 can distinguish between voice calls and text messages and misspelled street names are more common in text messages and irregularities in text messages can be weighted less than irregularities in voice call.

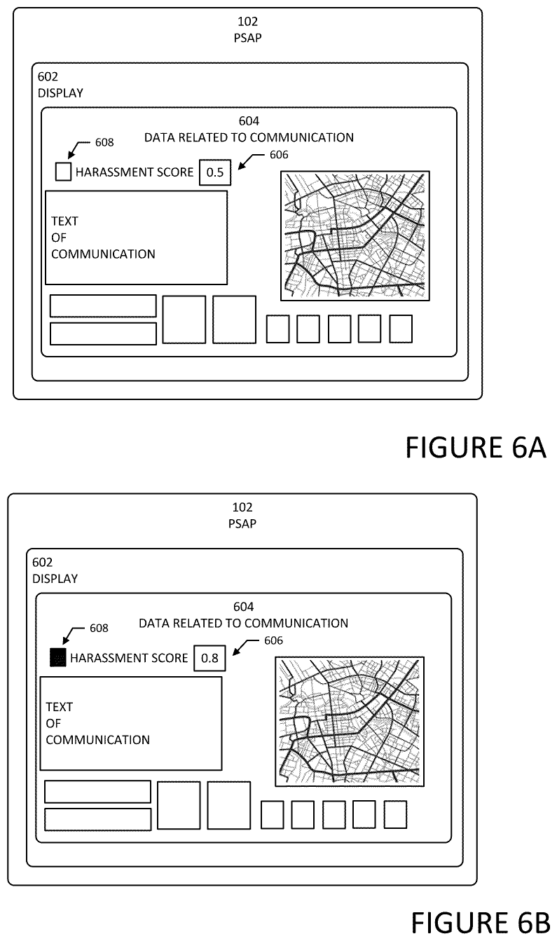

Turning to FIGS. 6A and 6B, FIGS. 6A and 6B are a simplified block diagrams illustrating specific example details to help enable identification of a harassment communication. In an example, the PSAP 102 can include a display 602. The display can include data 604 related to a communication that can be viewed by a PSAP operator to assist the PSAP operator when responding to the communication to the PSAP 102. In a specific example, the data 604 related to the communication can include a visual representation of the harassment confidence score 606 and/or a harassment indicator 608 that indicates whether or not the communication is likely to be a harassment communication.

In an illustrative example, a communication is received at the PSAP 102, the first phase harassment confidence score can be generated and displayed to the PSAP operator as the visual representation of the harassment confidence score 606. If the confidence score is above a threshold, the harassment indicator 608 can provide a quick visual que to the PSAP operator that the communication is likely to be related to harassment and caution should be taken, especially if the communication is an attempted swatting. For example, as illustrated in FIG. 6A, because the harassment confidence score is below a threshold, the harassment indicator 608 is not activated.

While the PSAP operator is interacting with the user that initiated the communication, the second phase harassment confidence score can be generated and displayed to the PSAP operator as the visual representation of the harassment confidence score 606. As illustrated in FIG. 6B, the harassment confidence score is above a threshold and the harassment indicator 608 is activated to alert the PSAP operator that the communication is likely to be related to harassment and caution should be taken, especially if the communication is an attempted swatting. In some examples, the visual representation of the harassment confidence score 606 is continuously updated to provide the PSAP operator a real time or near real time indication of whether or not the communication is possibly a harassment communication.

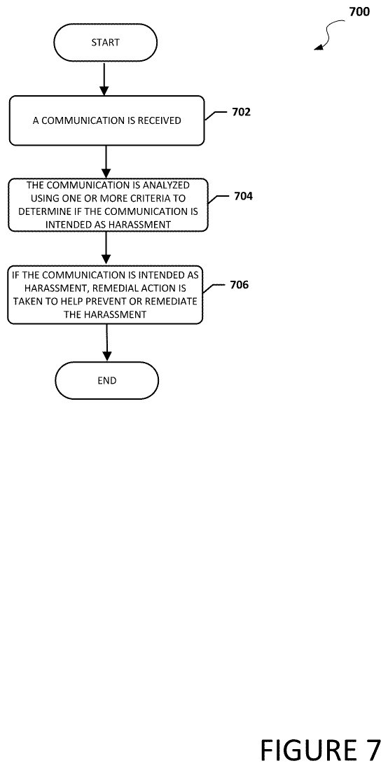

Turning to FIG. 7, FIG. 7 is example flowchart illustrating possible operations of a flow 700 that may be associated with potential operations to help enable identification of a harassment communication, in accordance with an embodiment of the present disclosure. Specifically, in some examples, one or more operations of flow 700 may be performed by the PSAP 102, the communication engine 104, the harassment communication detection engine 106, the check registry engine 202, the number attestation engine 204, the number properties engine 206, the IVR engine 208, the text script engine 210, the call/text analysis engine 212, the location engine 214, and/or the scoring engine 216. At 702, a communication is received. At 704, the communication is analyzed using one or more criteria to determine if the communication is intended as harassment. For example, the harassment communication detection engine 106 can analyze a communication received by the PSAP 102 to try and determine if the communication is intended as harassment, and in particular, if the communication is a swatting attempt. At 706, if the communication is intended as harassment, remedial action is taken to help prevent or remediate the harassment. For example, if the harassment communication detection engine 106 determines that the communication may be intended as harassment, a harassment confidence score can be used to inform a PSAP operator that the communication may be intended as harassment and the PSAP operator needs to exercise caution when dispatching emergency services in response to the communication. In some examples, the communication can be sent to an IVR to try and deter or stop the harassing communication.

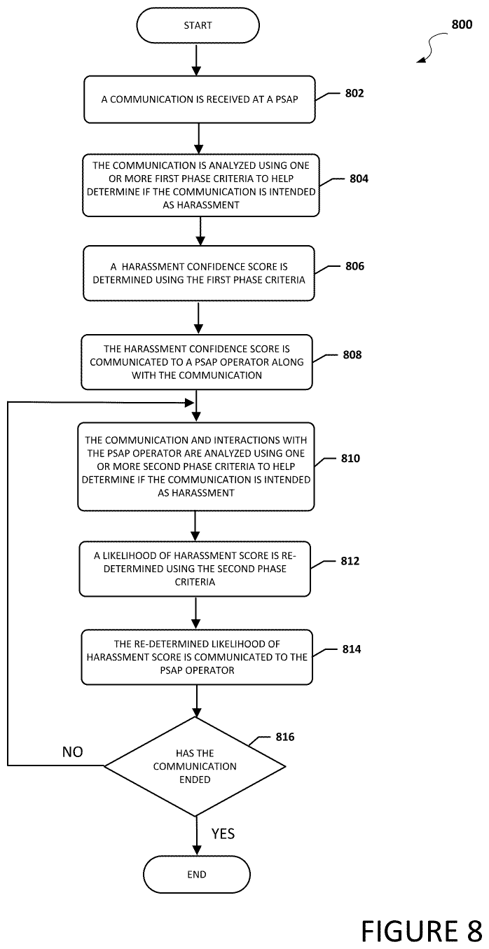

Turning to FIG. 8, FIG. 8 is example flowchart illustrating possible operations of a flow 800 that may be associated with potential operations to help enable identification of a harassment communication, in accordance with an embodiment of the present disclosure. Specifically, in some examples, one or more operations of flow 800 may be performed by the PSAP 102, the communication engine 104, the harassment communication detection engine 106, the check registry engine 202, the number attestation engine 204, the number properties engine 206, the IVR engine 208, the text script engine 210, the call/text analysis engine 212, the location engine 214, and/or the scoring engine 216. At 802, a communication is received at a PSAP. At 804, the communication is analyzed using one or more first phase criteria to help determine if the communication is intended as harassment. For example, the harassment communication detection engine 106 can analyze a communication received by the PSAP 102 using one or more first phase criteria (e.g., as shown in FIG. 4) to try and determine if the communication is intended as harassment, and in particular, if the communication is a swatting attempt. The first phase uses data and metadata associated with the communication when the communication is first received at the PSAP 102. The data and metadata can include attestation of the phone number used for the communication, whether the communication was received on an administrative or non-emergency line instead of the 911 emergency line, whether the identity of the electronic device that initiated the can be determined, whether or not the phone number used for the communication is spoofed, and other data and metadata that can be collected when the communication is first received at the PSAP 102. At 806, a harassment confidence score is determined using the first phase criteria. For example, using the first phase criteria, the scoring engine 216 can determine a harassment confidence score for the communication. At 808, the harassment confidence score is communicated to a PSAP operator along with the communication.

At 810, the communication and interactions with the PSAP operator are analyzed using one or more second phase criteria to help determine if the communication is intended as harassment. For example, the harassment communication detection engine 106 can analyze the communication received by the PSAP 102 and the interaction between the PSAP operator and the user that initiated the communication using one or more second phase criteria (e.g., as shown in FIG. 5) to try and determine if the communication is intended as harassment, and in particular, if the communication is a swatting attempt. The second phase uses data, metadata, and attributes associated with the communication after the communication has been sent to the PSAP operator. For example, after the communication has been sent to the PSAP operator, IVR, or chatbot, the communication can be analyzed using the second phase criteria. More specifically, during the second phase when the PSAP operator IVR, or chatbot is communicating with the user that sent the communication, the subject or target of the communication can be identified, the location of the user that initiated the communication can be determined, if the communication is a voice call, features of the voice call (e.g., background, tone of the user that initiated the communication, etc.), the words spoken by the user that initiated the communication, and other data, metadata, and attributes associated with the communication after the communication can be determined and analyzed using the second phase criteria. For example, the subject or target of the communication may be on a registry of known possible victims likely to be harassed, the location of the electronic device that initiated the communication may not be in the same location as the area of the subject of the communication, the background of the communication may be silent, no other communication has been received about the subject of the communication, the user that initiated the communication may use incorrect street names when describing the subject of the communication, the voice or mannerisms of the user that initiated the communication may not be consistent with the subject of the communication, the relationship of the user that initiated the communication and the victim may suggest a harassment communication, and other data, metadata, and attributes that may be acquired during the communication.

At 812, a likelihood of harassment score is re-determined using the second phase criteria. For example, the likelihood of harassment score that was determined in 806 using the first phase criteria is updated using the second phase criteria. At 814, the re-determined likelihood of harassment score is communicated to the PSAP operator. At 816, the system determines if the communication has ended. If the communication has not ended, the communication and interactions with the PSAP operator continue to be analyzed using one or more second phase criteria to help determine if the communication is intended as harassment, as in 810. If the communication has ended, the process end. In some examples, collected data about the communication is stored to help train a computer model to detect communications intended as harassment, to help law enforcement capture and prosecute a malicious user, or for other reasons or purposes.

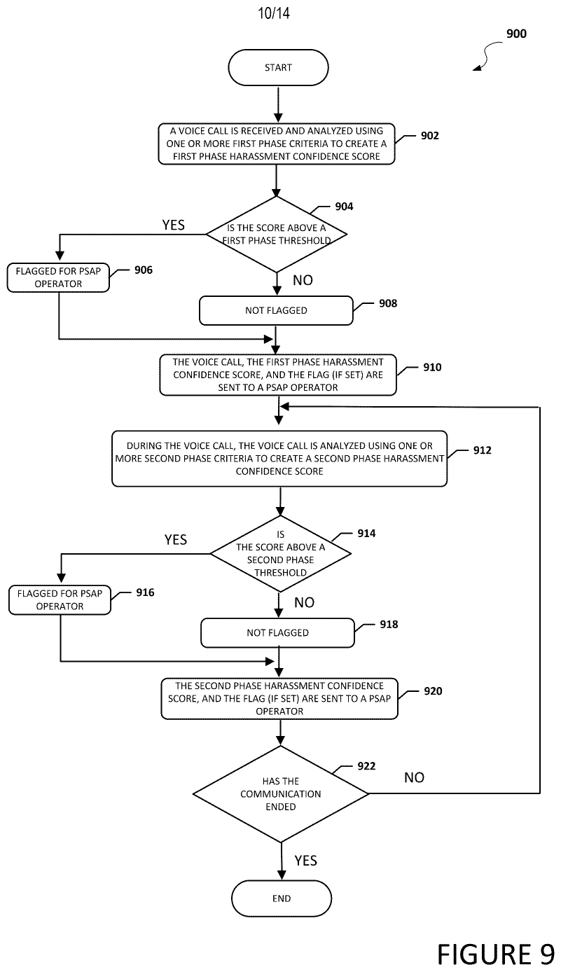

Turning to FIG. 9, FIG. 9 is example flowchart illustrating possible operations of a flow 900 that may be associated with potential operations to help enable identification of a harassment communication, in accordance with an embodiment of the present disclosure. Specifically, in some examples, one or more operations of flow 900 may be performed by the PSAP 102, the communication engine 104, the harassment communication detection engine 106, the check registry engine 202, the number attestation engine 204, the number properties engine 206, the IVR engine 208, the text script engine 210, the call/text analysis engine 212, the location engine 214, and/or the scoring engine 216. At 902, a voice call is received and analyzed using one or more first phase criteria to create a first phase harassment confidence score. For example, a voice call can be received by the PSAP 102 and the voice call can be analyzed using one or more first phase criteria to help determine if the voice call is intended as harassment. For example, the harassment communication detection engine 106 can analyze the voice call received by the PSAP 102 using one or more first phase criteria (e.g., as shown in FIG. 4) to try and determine if the voice call is intended as harassment, and in particular, if the voice call is a swatting attempt. Using the first phase criteria, the scoring engine 216 can determine a harassment confidence score for the voice call. At 904, the system determines if the first phase harassment confidence score is above a first phase threshold, as in 906. If the first phase harassment confidence score is above a first phase threshold, the voice call is flagged for the PSAP operator or a flag is set to alert the PSAP operator that the voice call may be related to harassment. If the first phase harassment confidence score is not above a first phase threshold, the voice call is not flagged as possibly being related to harassment, as in 908. At 910, the voice call, the first phase harassment confidence score, and the flag (if set) are sent to a PSAP operator.

At 912, during the voice call, the voice call is analyzed using one or more second phase criteria to create a second phase harassment confidence score. For example, the harassment communication detection engine 106 can analyze a communication received by the PSAP 102 and the interaction between the PSAP operator and the user that initiated the communication using one or more second phase criteria (e.g., as shown in FIG. 5) to try and determine if the communication is intended as harassment, and in particular, if the communication is a swatting attempt. Using the second phase criteria, the scorning engine 216 can determine a second phase harassment confidence score for the voice call. At 914, the system determines if the second phase harassment confidence score is above a second phase threshold, as in 916. If the second phase harassment confidence score is above a second phase threshold, the voice call is flagged for the PSAP operator or a flag is set to alert the PSAP operator that the voice call may be related to harassment. If the second phase harassment confidence score is not above a second phase threshold, the voice call is not flagged as possibly being related to harassment, as in 918. At 920, the second phase harassment confidence score, and the flag (if set) are sent to a PSAP operator. In some examples, the first phase harassment confidence score is updated. In some examples, the harassment confidence score can be displayed on a user interface and the harassment confidence score can be updated at periodic intervals or whenever the harassment confidence score changes. At 922, the system determines if the communication has ended. If the communication has not ended, the voice call continues to be analyzed using one or more second phase criteria to create a second phase harassment confidence score, as in 912. If the communication has ended, the process end. In some examples, collected data about the communication is stored to help train a computer model to detect communications intended as harassment, to help law enforcement capture and prosecute a malicious user, or for other reasons or purposes.

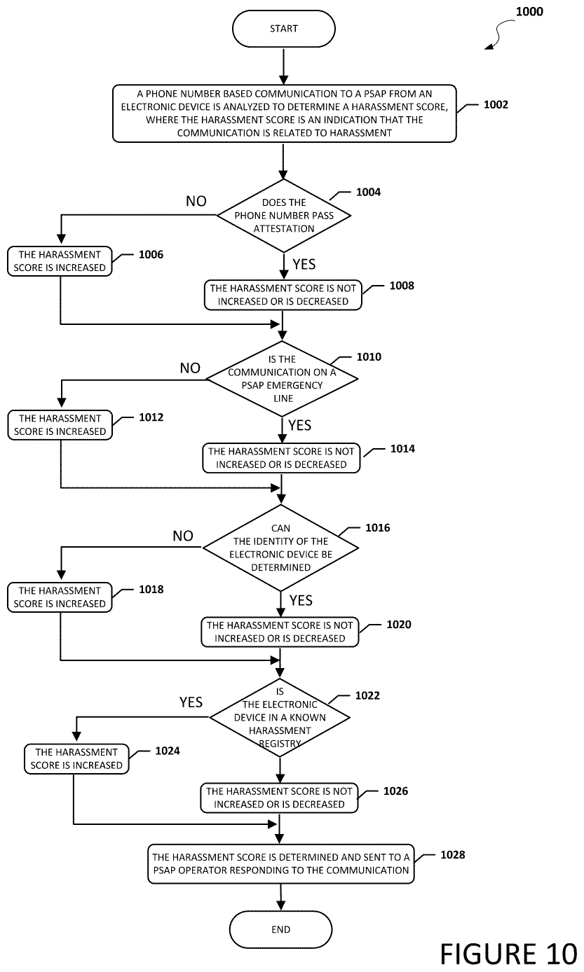

Turning to FIG. 10, FIG. 10 is example flowchart illustrating possible operations of a flow 1000 that may be associated with potential operations to help enable identification of a harassment communication, in accordance with an embodiment of the present disclosure. Specifically, in some examples, one or more operations of flow 1000 may be performed by the PSAP 102, the communication engine 104, the harassment communication detection engine 106, the check registry engine 202, the number attestation engine 204, the number properties engine 206, the IVR engine 208, the text script engine 210, the call/text analysis engine 212, the location engine 214, and/or the scoring engine 216. At 1002, a phone number-based communication to a PSAP from an electronic device is analyzed to determine a harassment score, where the harassment score is an indication that the communication is related to harassment. At 1004, the system determines if the phone number passes an attestation criteria. If the phone number does not pass an attestation criteria, the harassment score is increased, as in 1006. For example, if the attestation assigned to the phone number is a level C-attestation then the phone number does not pass the attestation criteria. In some examples, if the attestation assigned to the phone number is a level B-attestation or a level C-attestation then the phone number does not pass the attestation criteria and the phone number passes the attestation criteria only if the phone number has a level A-attestation. If the phone number does pass an attestation criteria, the harassment score is not increased, as in 1008.

At 1010, the system determines if the communication to the PSAP is on a PSAP emergency line (911 emergency line). For example, the numbers property engine 206 can determine if the communication was received on an administrative line rather than the emergency 911 line. If the communication is not on a PSAP emergency line, the harassment score is increased, as in 1012. If the communication was received on a PSAP emergency line, the harassment score is not increased, as in 1014.

At 1016, the system determines if the identity of the electronic device can be determined. For example, the number properties engine 206 can determine if the electronic device that initiated the communication is a mobile phone, a non-service initialized mobile phone, a VOIP communication, spoofed number, etc. and try to determine the identity of the electronic device. If the identity of the electronic device cannot be determined, the harassment score is increased, as in 1018. If the identity of the electronic device can be determined, the harassment score is not increased, as in 1020.

At 1022, the system determines if the electronic device is in a known electronic device harassment registry. For example, if the identity of the phone can be determined, the check registry engine 202 can search one or more know malicious device registries to determine if the electronic device that initiated the communication is listed on a malicious device registry. If the electronic device is in a known electronic device harassment registry, the harassment score is increased, as in 1024. If the electronic device is not in a known electronic device harassment registry, the harassment score is not increased, as in 1026. At 1028, the harassment score is determined and sent to a PSAP operator responding to the communication. For example, the scorning engine 216 can determine a harassment confidence score for the phone number-based communication and the harassment confidence score can be sent to the PSAP operator. In some examples, the communication is sent to the PSAP operator and the harassment confidence score is sent after the communication is received by the PSAP operator.

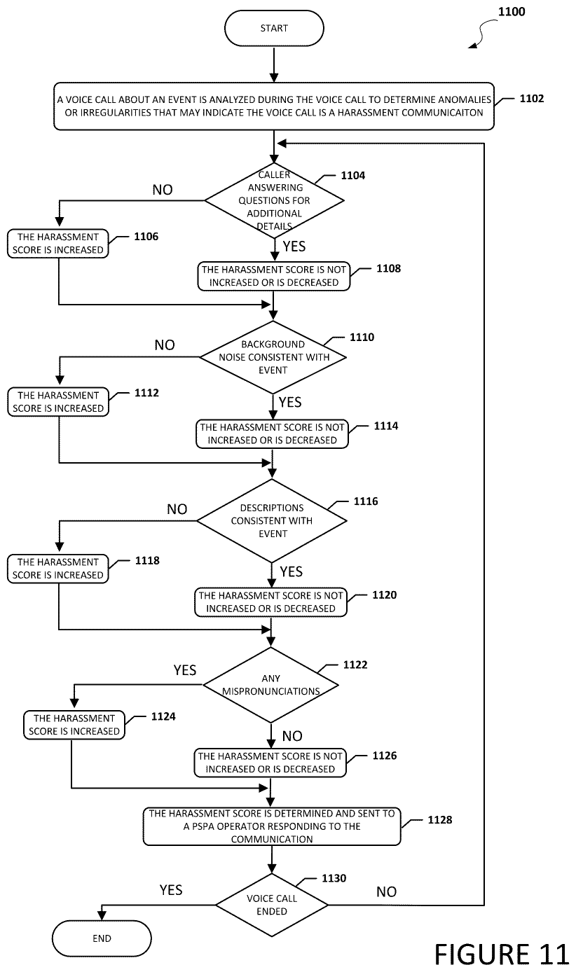

Turning to FIG. 11, FIG. 11 is example flowchart illustrating possible operations of a flow 1100 that may be associated with potential operations to help enable identification of a harassment communication, in accordance with an embodiment of the present disclosure. Specifically, in some examples, one or more operations of flow 1100 may be performed by the PSAP 102, the communication engine 104, the harassment communication detection engine 106, the check registry engine 202, the number attestation engine 204, the number properties engine 206, the IVR engine 208, the text script engine 210, the call/text analysis engine 212, the location engine 214, and/or the scoring engine 216. At 1102, a voice call about an event is analyzed during the voice call to determine anomalies or irregularities that may indicate the voice call is a harassment communication. At 1104, the system determines if the caller is answering questions for additional details related to the event. For example, if the caller is attempting a harassment communication, the caller may not want to stay connected and talking to the PSAP operator out of fear of being caught. If the caller is not answering questions for additional details related to the event, the harassment score in increased, as in 1106. If the caller is answering questions for additional details related to the event, the harassment score is not increased, as in 1108.

At 1110, the system determines if background noise during the voice call is consistent with the event or reason for the voice call. For example, the background may be silent when wind, traffic, or outdoor noises should be present in the background. If background noise during the voice call is not consistent with the event or reason for the voice call, the harassment score in increased, as in 1112. If background noise during the voice call is consistent with the event or reason for the voice call, the harassment score is not increased, as in 1114.

At 1116, the system determines if descriptions during the voice call are consistent with the event or reason for the voice call. For example, cross streets may be incorrect, the description of the area around the event may be incorrect, the description of the event itself may be incorrect or not consistent with the event if the event was actually occurring, etc. If descriptions during the voice call are not consistent with the event or reason for the voice call, the harassment score in increased, as in 1118. If descriptions during the voice call are consistent with the event or reason for the voice call, the harassment score is not increased, as in 1120.

At 1122, the system determines if there are mispronunciations during the voice call. For example, the subject of the voice call may be mispronounced (e.g., the name of an intended swatting victim may be mispronounced), cross streets may be mispronounced, etc. If there are mispronunciations during the voice call, the harassment score in increased, as in 1124. If there are no mispronunciations during the voice call, the harassment score is not increased, as in 1126. At 1128, the harassment score is determined and sent to a PSAP operator responding to the communication. For example, the scorning engine 216 can determine a harassment confidence score for the voice call. At 1130, the system determines if the call has ended. If the call has not ended, the system returns to 1104 and determines if the caller is answering questions for additional details.

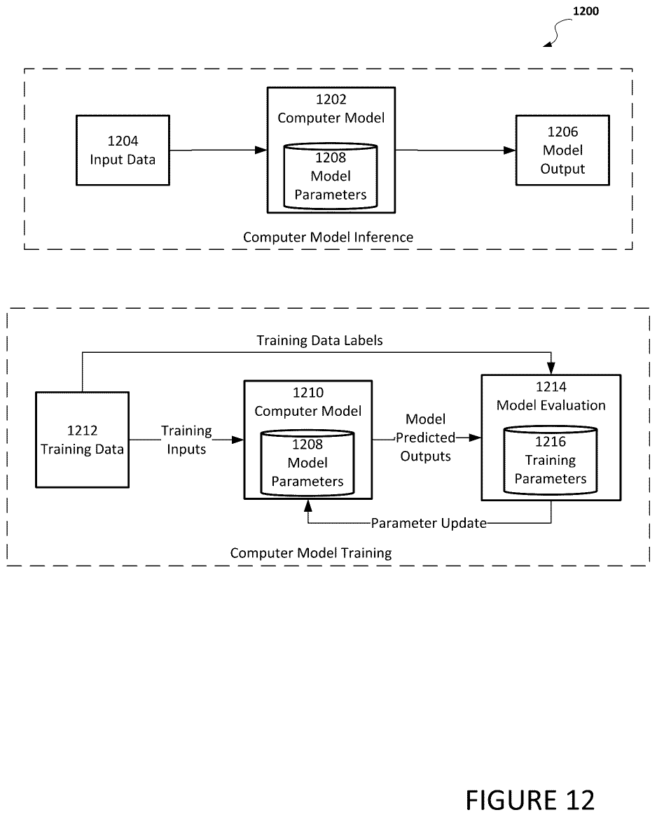

Turning to FIG. 12, FIG. 12 illustrates example computer model inference and computer model training 1200. Computer model inference refers to the application of a computer model 1202 to a set of input data 1204 to generate an output or model output 1206. The computer model 1202 determines the model output 1206 based on parameters of the model, also referred to as model parameters 1208. The parameters of the model may be determined based on a training process that finds an optimization of the model parameters 1208, typically using training data and desired outputs of the model for the respective training data as discussed below. The output (e.g., the identification of a harassment communication to a PSAP) of the computer model 1202 may be referred to as an “inference” because it is a predictive value based on the input data 1204 and based on previous example data used in the model training.

The input data 1204 and the model output 1206 vary according to the particular use case. For example, to determine the identification of a harassment communication to a PSAP analysis, the input data 1204 may be a text or audio communication and the output or “inference” may be a confidence score related to the identification of a harassment communication. In an illustrative example, the input data 1204 may include a vector, such as a sparse vector, representing information about an object. For example, in recommendation systems, such a vector may represent user-object interactions, such that the sparse vector indicates individual items positively rated by a user. In addition, the input data 1204 may be a processed version of another type of input object, for example representing various features of the input object or representing preprocessing of the input object before input of the object to the computer model 1202. As one example, the input object, such as a sparse vector discussed above, may be processed to determine an embedding or another compact representation of the input object that may be used to represent the object as the input data 1204 in the computer model 1202. Such additional processing for input objects may themselves be learned representations of data, such that another computer model processes the input objects to generate an output that is used as the input data 1204 for the computer model 1202. Although not further discussed here, such further computer models may be independently or jointly trained with the computer model 1202. As noted above, the model output 1206 may depend on the particular application of the computer model 1202, for example, identification of a harassment communication.

The computer model 1202 includes various model parameters 1208, as noted above, that describe the characteristics and functions that generate the model output 1206 from the input data 1204. In particular, the model parameters 1208 may include a model structure, model weights, and a model execution environment. The model structure may include, for example, the particular type of computer model 1202 and its structure and organization. For example, the model structure may designate a neural network, which may be comprised of multiple layers, and the model parameters 1208 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 1202 processes the input data 1204 to the model output 1206. Each portion or layer of the computer model 1202 may have such weights. For example, weights may be used to determine values for processing inputs to determine outputs at a particular portion of a model. Stated another way, for example, model weights may describe how to combine or manipulate values of the input data 1204 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer.

The model execution parameters represent parameters describing the execution conditions for the model. In particular, aspects of the model may be implemented on various types of hardware or circuitry for executing the computer model 1202. For example, portions of the model may be implemented in various types of circuitry, such as general-purpose circuity (e.g., a general CPU), circuity specialized for certain functions (e.g., a GPU or programmable Multiply-and-Accumulate circuit) or circuitry specially designed for the particular computer model application. In some configurations, different portions of the computer model 1202 may be implemented on different types of circuitries. As discussed below, training of the model may include optimizing the types of hardware used for certain aspects of the computer model 1202 (e.g., co-trained), or may be determined after other parameters for the computer model 1202 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters 1208 for the computer model 1210. During training, the model parameters 1208 are optimized to “learn” values of the model parameters (such as individual weights, activation values, model execution environment, etc.), that improve the model parameters 1208 based on an optimization function that seeks to improve a cost function (also sometimes termed a loss function). Before training, the computer model 1210 has model parameters 1208 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 1212 includes a data set to be used for training the computer model 1210. The data set varies according to the particular application and purpose of the computer model 1210. In supervised learning tasks, the training data 1212 typically includes a set of training data labels that describe the training data 1212 and the desired output of the model relative to the training data 1212. For example, for classifying communications as harassment, the training data 1212 may include previous communications that are labeled with the classification of a harassment communication. For this task, the training data 1212 may include swatting attempts and training data labels that label the swatting attempts as swatting attempts, such that the computer model 1210 is intended to learn to also label similar communications as a swatting attempt. In another example, the training data 1212 may include various communications to a PSAP labeled with a harassment communication such that the computer model 1210 is intended to learn to also classify similar communications as a harassment communication.

To train the computer model 1210, a training module (not shown) applies the training inputs to the computer model 1210 to determine the outputs predicted by the model for the given training inputs. The training module, though not shown, is a computing module used for performing the training of the computer model 1210 by executing the computer model 1210 according to its inputs and outputs given the model's parameters and modifying the model parameters based on the results. The training module may apply the actual execution environment of the computer model 1210, or may simulate the results of the execution environment, for example to estimate the performance, runtime, memory, or circuit area (e.g., if specialized hardware is used) of the computer model 1210. The training module, along with the training data 1212 and model evaluation, may be instantiated in software and/or hardware by one or more processing devices. In various examples, the training process may also be performed by multiple computing systems in conjunction with one another, such as distributed/cloud computing systems. In some examples the training of the computer model 1210 may be different if the computer model 1210 is a large language model (LLM) used for script responses as compared to being used to classify incoming communications to the PSAP. A LLM is used for language-based tasks, whereas the general computer model can be used for a variety of other tasks, including the identification of harassment communications to the PSAP.

After processing the training inputs according to the current model parameters for the computer model 1210, the model's predicted outputs are evaluated and the computer model 1210 is evaluated with respect to the cost function and optimized using an optimization function of the training model. Depending on the optimization function, particular training process and training parameters 1216 after the model evaluation are updated to improve the optimization function of the computer model 1210. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model 1210 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 1210 structure and execution environment (e.g., to evaluate or modify these model parameters).

After determining results of the cost function, the optimization function determines a modification of the model parameters to improve the cost function for the training data 1212. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters 1216 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 1212 is batched and the parameter updates are iteratively applied to batches of the training data 1212. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 1212 available or the incremental improvements in model parameters are below a threshold (e.g., additional training data 1212 no longer continues to improve the model parameters). Additional training parameters 1216 may describe the batch size for the training data 1212, a portion of training data 1212 to use as validation data, the step size of parameter updates, a learning rate of the model, and so forth. Additional techniques may also be used to determine global optimums or address nondifferentiable model parameter spaces.

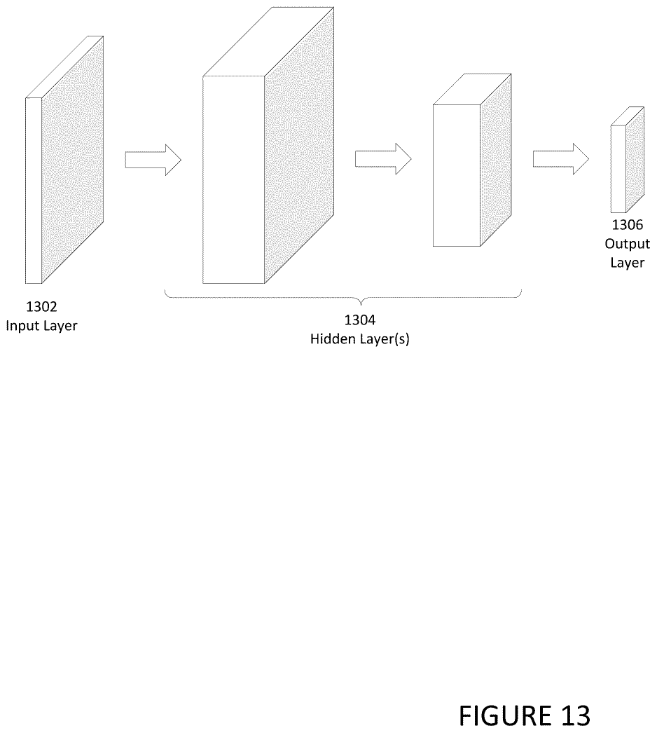

Turning to FIG. 13, FIG. 13 illustrates an example neural network architecture. In general, a neural network includes an input layer 1302, one or more hidden layers 1304, and an output layer 1306. The values for data in each layer of the network is generally determined based on one or more prior layers of the network. Each layer of a network generates a set of values, termed “activations” that represent the output values of that layer of a network and may be the input to the next layer of the network. For the input layer 1302, the activations are typically the values of the input data, although the input layer 1302 may represent input data as modified through one or more transformations to generate representations of the input data. For example, in recommendation systems, interactions between users and objects may be represented as a sparse matrix. Individual users or objects may then be represented as an input layer 1302 as a transformation of the data in the sparse matrix relevant to that user or object. The neural network may also receive the output of another computer model (or several), as its input layer 1302, such that the input layer 1302 of the neural network shown in FIG. 13 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network, except for the final output layer of 1306 of the network.

Each layer of the neural network typically represents its output activations (i.e., also termed its outputs) in a matrix, which may be 1, 2, 3, or n-dimensional according to the particular structure of the network. As shown in FIG. 13, the dimensionality of each layer may differ according to the design of each layer. The dimensionality of the output layer 1306 depends on the characteristics of the prediction made by the model. For example, a computer model for multi-object classification may generate an output layer 1306 having a one-dimensional array in which each position in the array represents the likelihood of a different classification for the input layer 1302. In another example for classification of portions of an image, the input layer 1302 may be an image having a resolution, such as 512×512, and the output layer may be a 512×512xn matrix in which the output layer 1306 provides n classification predictions for each of the input pixels, such that the corresponding position of each pixel in the input layer 1302 in the output layer 1306 is an n-dimensional array corresponding to the classification predictions for that pixel.

The hidden layers 1304 provide output activations that variously characterize the input layer 1302 in various ways that assist in effectively generating the output layer 1306. The hidden layers thus may be considered to provide additional features or characteristics of the input layer 1302. Though two hidden layers are shown in FIG. 13, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 1306. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 1302 is reached.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/−20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable identification of a harassment communication in that any suitable arrangements, chronologies, configurations, and timing mechanisms may be provided without departing from the teachings of the present disclosure.

Note that embodiments of the electronic device 108 and the PSAP 102 may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, each of the nodes, the electronic device 108 and the PSAP 102 can also include suitable interfaces for receiving, transmitting, and/or otherwise communicating data or information in a network environment.

The electronic device 108 and the PSAP 102 and other associated or integrated components can include one or more memory elements for storing information to be used in achieving operations associated with enabling identification of a harassment communication, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the communication system 100 could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling identification of a harassment communication, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out the identification of a harassment communication described in this Specification. Regarding a physical implementation of the electronic device 108 and the PSAP 102 and their associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and a method to enable identification of a harassment communication and their teachings are readily scalable and can accommodate a large number of components, as well as more complicated/sophisticated arrangements and configurations. Accordingly, the examples provided should not limit the scope or inhibit the broad teachings of the system, apparatus, and method to enable identification of a harassment communication and as potentially applied to a myriad of other architectures.

It is also important to note that the operations in the preceding flow diagrams (i.e., FIGS. 7-11) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method for identification of a harassment communication, the method comprising:
analyzing a communication from an electronic device to a public-safety answering point (PSAP);
determining a harassment confidence score that indicates a likelihood the communication is a harassment communication; and
sending the communication and the determined harassment confidence score for the communication to a human operator at the PSAP.

2. The method of claim 1, wherein a computer model is used to determine the harassment confidence score for the communication.

3. The method of claim 2, wherein the communication is an attempted swatting communication.

4. The method of claim 1, wherein at least one criteria used to create the harassment confidence score includes one or more properties of a phone number used in the communication.

5. The method of claim 1, wherein at least one criteria used to create the harassment confidence score includes an attestation of a phone number associated with the communication.

6. The method of claim 1, wherein at least one criteria used to create the harassment confidence score includes a target of the communication being included in an anti-harassment registry.

7. The method of claim 1, wherein an interactive voice response system (IVR) is used obtain additional details related to the communication.

8. The method of claim 1, wherein, after the human operator receives the communication, the harassment confidence score is updated during an interaction between the human operator at the PSAP and a user that initiated the communication.

9. A system for identification of a harassment communication, comprising:
memory;
at least one processor;
a harassment communication detection engine configured to:
analyze a communication from an electronic device to a PSAP before a human operator at the PSAP receives the communication;
determine a first phase harassment confidence score that indicates a likelihood the communication is a harassment communication;
send the communication and the determined first phase harassment confidence score for the communication to a human operator at the PSAP;
after the human operator receives the communication and during an interaction between the human operator at the PSAP and user that initiated the communication, use a computer model to determine a second phase harassment confidence score that further indicates the likelihood the communication is a harassment communication; and
update the first phase harassment confidence score with the second phase harassment confidence score.

10. The system of claim 9, wherein the second phase harassment confidence score is updated during the interaction between the human operator at the PSAP and the user that initiated the communication.

11. The system of claim 9, wherein the communication is a phone call communication.

12. The system of claim 11, wherein criteria used to determine the first phase harassment confidence score includes attestation of a phone number associated with the communication, whether or not an identity of the electronic device that initiated the communication can be determined, and/or whether or not the phone number associated with the communication is spoofed.

13. The system of claim 9, wherein criteria used to determine the second phase harassment confidence score includes data and metadata that is acquired during the interaction between the human operator at the PSAP and user that initiated the communication.

14. The system of claim 9, wherein the communication is an attempted swatting communication.

15. A method, comprising:
determining a first phase harassment confidence score for a communication from an electronic device before a human operator receives the communication, wherein the first phase harassment confidence score indicates a likelihood the communication is a harassment communication; and
after the human operator receives the communication and during an interaction between the human operator and user that initiated the communication, using a computer model to determine a second phase harassment confidence score that further indicates the likelihood the communication is a harassment communication.

16. The method of claim 15, wherein the first phase harassment confidence score is communicated to the human operator as a visual representation of a harassment confidence score when human operator receives the communication.

17. The method of claim 16, wherein the visual representation of the harassment confidence score is updated using the second phase harassment confidence score.

18. The method of claim 15, wherein the human operator is a public-safety answering point operator.

19. The method of claim 15, wherein criteria used to determine the first phase harassment confidence score includes attestation of a phone number associated with the communication, whether or not an identity of the electronic device that initiated the communication can be determined, and/or whether or not the phone number associated with the communication is spoofed.

20. The method of claim 15, wherein the communication is related to a swatting attempt.
